(19) United States
(12) Patent Application Publication
(10) Pub. No.: US 2026/0099928 A1
(43) Pub. Date: Apr. 9, 2026

(54) MOTION TRACKING WITH INTEGRATED POSE ESTIMATION AND SEGMENTATION

(71) Applicant: Sword Health, S.A., Porto (PT)

(72) Inventors: Pedro Henrique Oliveira Santos, Porto (PT); Ricardo Miguel Pontes Leonardo, Porto (PT); Jossé Carlos Coelho Alves, Porto (PT); Paula Alexandra Canals Guerreiro, Porto (PT)

(21) Appl. No.: 18/907,402

(22) Filed: Oct. 4, 2024

(51) Int. Cl. G06T 7/246; A63B 24/00; A63B 71/06; G06T 7/12; G06V 10/26; G06V 40/10

(52) U.S. Cl. CPC G06T 7/248; A63B 24/0062; A63B 71/0622; G06T 7/12; G06V 10/26; G06V 40/10; A63B 2024/0068; A63B 2220/05; A63B 2220/806; A63B 2220/807; A63B 2230/62; G06T 2200/24; G06T 2207/10024; G06T 2207/30196

(57) ABSTRACT

A method and system for motion tracking that integrates pose estimation and segmentation. The method includes accessing a first set of keypoints generated by processing at least one image of a body area of a person. The first set of keypoints can be generated via pose estimation. The method further includes processing the at least one image to generate a body mask subsequently filtered to identify a second set of body contour keypoints, executing a predetermined function to identify a new keypoint based on the first set of keypoint and the second set of keypoints, generating a third set of keypoints based on the first set of keypoints and the new keypoint, and tracking the third set of keypoints to generate motion tracking data. The method generates feedback for the person based on the motion tracking data. The new keypoint and/or feedback can be generated based on a physical activity.

### TECHNICAL FIELD

The disclosed subject matter relates generally to the technical fields of motion tracking systems and digital health technologies. More specifically, but not exclusively, subject matter in the present disclosure relates to keypoint generation with integrated pose estimation and segmentation that can be applied in the context of a digital therapy platform.

### BACKGROUND

Recent algorithmic advances together with the wide availability of image and video capturing technology have led to an increased interest in the development or refinement of motion estimation and motion tracking technology. Motion tracking can be used in a variety of settings, including, for example, media or entertainment use cases, training simulations, or medical and rehabilitation use cases.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a block diagram illustrating a networked computing environment and a platform within which various example embodiments described herein may be deployed, according to some examples.

FIG. 2 is a block diagram illustrating a view of a motion tracking component, according to some examples.

FIG. 3 is a flowchart describing a keypoint generation method, according to some examples.

FIG. 4 is a flowchart describing a keypoint generation method, according to some examples.

FIG. 5 is an illustration of views of keypoint generation for back movements, according to some examples.

FIG. 6 is an illustration of views of keypoint generation for back movements, according to some examples.

FIG. 7 is an illustration of views of keypoint generation for back movements, according to some examples.

FIG. 8 is an illustration of views of keypoint generation for a quadricep stretch, according to some examples.

FIG. 9 is an illustration of a view of keypoint generation for a quadricep stretch, according to some examples.

FIG. 10 is a block diagram illustrating a view of a digital therapy platform interacting with a patient messaging system and a user device of a therapist, according to some examples.

FIG. 11 is a block diagram illustrating a view of a digital therapy platform, according to some examples.

FIG. 12 is a flowchart outlining operations in a session in the context of a digital therapy platform, according to some examples.

FIG. 13 is an illustration of a view of a user interface (UI) for a digital therapy platform, according to some examples.

FIG. 14 is an illustration of a view of a UI for a digital therapy platform, according to some examples.

FIG. 15 is an illustration of a view of a UI for a digital therapy platform, according to some examples.

FIG. 16 is an illustration of a view of a UI for a digital therapy platform, according to some examples.

FIG. 17 is an illustration of a view of a UI for a digital therapy platform, according to some examples.

FIG. 18 is an illustration of a view of a UI for a digital therapy platform, according to some examples.

FIG. 19 is an illustration of a view of a UI for a digital therapy platform, according to some examples.

FIG. 20 is an illustration of a view of a UI for a digital therapy platform, according to some examples.

FIG. 21 is a block diagram showing a software architecture for a computing device, according to some examples.

FIG. 22 is a block diagram of a machine in the form of a computer system, according to some examples, within which instructions may be executed for causing the machine to perform any one or more of the methodologies discussed herein.

### DETAILED DESCRIPTION

Pose estimation and motion tracking technologies can be used to detect and analyze a person's pose in one or more images, or to track a person's movements across a series of images, such as sequences of video frames.

Many current pose estimation and pose tracking methods rely on a predefined set of landmarks for a person's body. These keypoints can include, for example, facial keypoints, such as the person's nose, eyes or chin, or body joints. For example, the BlazePose model from Google^{TM} for on-device pose estimation and tracking uses a set of 33 keypoints, including, for example, hip, shoulder, knee or wrist landmarks, facial keypoints, and so forth. A computing system executing such pose estimation and/or tracking methods can compute the locations of these landmarks in one or more images, and use the sets of computed locations as representations of the poses of the person's body in the one or more images.

However, many movements and/or physical activities performed by a person require, or benefit from, tracking of body parts not represented by these standard landmarks, such as specific points along a person's back or a person's neck for movements involving back bending, back extension, neck stretching, and so forth. A computing system or application relying on an overly sparse set of keypoints or landmarks when assessing a person's execution of a movement or physical activity may generate suboptimal assessments. Furthermore, such a computing system or application can be limited with respect to the accuracy and usefulness of feedback provided to the person.

Trained keypoint-based pose estimation and tracking models can also show inconsistent performance when processing or labeling body positions outside of their training data, for example failing to detect or localize all predetermined keypoints. In such cases, calculating additional keypoints, updating the information for specific localized keypoints, or filtering noisily identified or tracked keypoints can improve the performance of motion tracking and analysis.

Examples described in the disclosure herein refer to a keypoint generation method and system for augmenting, refining, or filtering a set of keypoints used for pose estimation, pose tracking, and/or motion tracking. For convenience and brevity, the disclosure herein uses “motion tracking” to refer to any of these use cases, as well as other motion tracking-related tasks (see, for example, the GLOSSARY section for more details). In some examples, motion tracking can be used by a platform or system that monitors and/or assesses physical activities performed by a person in order to provide timely and useful feedback. For example, current digital therapy systems for physical therapy and rehabilitation use a variety of motion tracking-related technologies to track or assess a patient's completion of a recommended exercise or exercise regimen. Such digital therapy systems can then provide feedback to the patient, provide information to a therapist designing and/or monitoring a therapy program, and so forth (see, e.g., “DIGITAL THERAPY PLATFORM” in the GLOSSARY section for more details).

In some examples, given an image of a person's body, the keypoint generation system generates a first set of keypoints by processing the image. The initial set of keypoints can be obtained by using a pose estimation model, such as a trained machine learning (ML) model, to process the at least one image. The initial set of keypoints can include keypoints representative of the head region (e.g., ears, or facial keypoints such as eyes, nose, or mouth) and/or joint landmarks, such as hip landmarks, shoulder landmarks, knee landmarks, wrist landmarks, finger joints, and so forth. However, this first set of keypoints may lack keypoints corresponding to other body parts such as the back, the neck and so forth. Furthermore, identifying keypoint locations in the image can be difficult or noisy in the case of certain poses less expected by the pose estimation model. For example, a pose including a person's foot being placed on the person's backside can lead to suboptimal tracking of keypoints or landmarks corresponding to a leg, ankle, foot, or toes, etc. Thus, in some examples, the keypoint generation system implements a strategy for updating the first set of keypoints based on further processing of the image, in order to improve the keypoint representation available for motion tracking uses.

In some examples, the keypoint generation system processes the image of the body to generate a body mask (for example, a segmentation mask) indicating, for areas of the image, the likelihood that each area corresponds to an area of the person's body. The keypoint generation system can, in some examples, use the pose estimation model to generate the body mask (e.g., the segmentation mask, etc.) as an output. Alternatively, the keypoint generation system can use a separate segmentation model or body detection model to generate the body mask or segmentation mask. The keypoint generation system processes or filters the body mask to identify body contour points. In some examples, a segmentation mask includes pixels with corresponding numerical values associated with the body or body contour of the person. The keypoint generation system filters the segmentation mask pixels based on a predefined range of values to identify pixels likely to correspond to body contour pixels. One or more of the filtered pixels may be retained as a second set of keypoints.

In some examples, given the first set of keypoints (e.g., corresponding to initial landmarks) and the second set of keypoints (e.g., corresponding to the body contour of the person), the keypoint generation system applies a predefined function to identify one or more keypoints that can be used to improve monitoring and/or assessing a person's movements over a series of images, such as a series of video frames. The keypoint generation system generates a third set of keypoints that incorporates some or all of the first set of keypoints (corresponding to the initial landmarks) and/or one or more of the newly identified or generated keypoints. The third set of keypoints corresponds to an updated keypoint set for improved further motion tracking uses. As detailed below, identifying one or more keypoints for inclusion in the third set of keypoints includes, in some examples, selecting one or more of the keypoints in the second set of keypoints based on one or more strategies and/or mathematical functions (see, e.g., the cat-cow movement example). Identifying or generating one or more keypoints for inclusion in the third set of keypoints can include, in some examples, producing entirely new keypoints not previously included in the second set of keypoints (see, e.g., the quadricep stretch example). Producing such keypoints can include, for example, selecting one or more points and/or their associated coordinates from among points within the body of the person that are not included in the set of initially detected body contour points. The respective selection of such points is based on one or more strategies and/or mathematical functions, as detailed below. Thus, in some examples, the keypoint generation system can augment and/or update an initial landmark set (e.g., corresponding to the first set of keypoints) with keypoints selected from the second set of keypoints and/or produced based on the first set of keypoints and/or body mask information.

In some examples, the predefined function applied by the keypoint generation system can take into account a pre-determined physical movement or physical activity, ensuring that the generated keypoints are directly relevant to the monitoring and/or assessing of the physical activity or movement.

In some examples, the keypoint generation system operates as a keypoint generation component of a motion tracking system or motion tracking component. The keypoint generation system can execute the operations described above for each of a series of images, such as video frames. Thus, the keypoint generation system or component can enable the tracking of the third set of keypoints throughout the series of images or video frames, generating motion tracking data for the respective person. A computing system can use such motion tracking data to generate and/or present feedback for the person performing a physical activity. In some examples, the computing system can provide, via a UI of a computing device, an instruction to the person to perform the physical activity of interest, or provide real-time or post-session feedback with respect to the person's execution of the physical activity. Examples of such computing systems include applications or platforms recommending, tracking and/or assessing fitness-related or wellness-related activities, as well as systems for alternative use cases such as virtual reality (VR) or augmented reality (AR) applications, motion tracking for film or video game production, and so forth (as further detailed below).

In some examples, identifying a new keypoint includes determining an area based on the first set of keypoints and/or generating a set of intermediate points in the respective area. The keypoint generation system computes, for each keypoint in the second set of body contour keypoints, a value of a predetermined measure based on the respective keypoint, the set of intermediate points and/or the set of first keypoints. The body contour keypoint whose associated value optimizes one or more predetermined selection criteria is retained as a new keypoint to be included in the final, third set of keypoints for further tracking of the person's movements. The procedure for generating intermediate points, the predetermined measure and/or the selection criteria used to select body contour points as new keypoints can be associated with specific physical activities, such as movements of the back, movements involving the stretching of the neck, a quadricep stretch and other movements involving leg stretching, and so forth.

In some examples, generating the set of intermediate points includes generating a segment based on two or more landmarks retrieved from the first set of keypoints. The predetermined measure can correspond to a distance measure based on each keypoint of the second set of keypoints and one or more points on the generated segment or an extension of the generated segment. In an illustrative example for computing such a predetermined measure, the keypoint generation system can generate a reference vector using at least the generated segment. For each keypoint of a selection of the second set of keypoints, the keypoint generation system can generate a candidate vector based on the keypoint and a keypoint of the segment, and then compute a keypoint-associated indicator value based on the two vectors (the candidate vector and the reference vector). The indicator value can correspond to the angle between the two vectors, the inner product of the two vectors, and so forth. In some examples, selecting the new keypoint includes selecting a keypoint of the second set of keypoints associated with an indicator value (e.g., an angle) of a set of computed indicator values associated with the second set of keypoints, wherein the indicator value satisfies a predefined selection criterion (e.g., minimum angle of a set of angles, etc.). In an alternative example, selecting the new keypoint can correspond to selecting the keypoint of the second set of keypoints that is closest to the extension of the generated segment.

In some examples, identifying a new keypoint is based on one or more segments, each segment based on a landmark of the first set of keypoints or a body contour point, and/or one of at least an additional landmark of the first set of keypoints, an additional body contour point and/or a coordinate axis. In an illustrative example, a first segment can be generated based on at least a first landmark of the first set of keypoints and a first contour point of the second set of keypoints or a coordinate axis. A second segment can be generated based on at least a second landmark of the first set of keypoints and a second contour point of the second set of keypoints or a coordinate axis. Given the two segments, identifying the new keypoint corresponds to determining an intersection of the first segment and the second segment. In some examples, more than two segments and a plurality of operations can be used (e.g., intersection, translation, and other operations or transformations known in art).

The two examples below illustrate the functionality of the keypoint generation system for two physical activities, for illustration purposes only. As disclosed herein, additional physical activities can be handled similarly, or according to different example embodiments based on the structure of the keypoint generation system.

In an illustrative example of a back extension physical activity such as a cat-cow movement, the keypoint generation system generates a set of intermediate back keypoints by retrieving, from a first set of keypoints, hip landmarks and shoulder landmarks, generating a first midpoint between the right hip landmark and the left hip landmark, generating a second midpoint between the right shoulder landmark and the left shoulder landmark, and generating intermediate back keypoints between the first midpoint and the second midpoint based on a predetermined generation criterion (e.g., equidistant points on the first midpoint-second midpoint segment, etc.). The keypoint generation system can generate a back orthogonal vector perpendicular to a vector generated based on the first midpoint and the second midpoint, and use it to identify body contour points corresponding to the intermediate back keypoints. For example, for an intermediate back keypoint, the system can generate a candidate vector based on each of the body contour points of the second set of keypoints and the respective intermediate back keypoint. The system can additionally compute a measure (e.g., an angle, or the inner product) based on the candidate vector and the back orthogonal vector, and select the body contour point that optimizes the respective measure (e.g., minimizes the angle between the candidate vector and the back orthogonal vector). The selected body contour point corresponds to the intermediate back keypoint, and can be added to the third set of keypoints to be used for improved motion tracking.

In an illustrative example of a quadricep stretch, the keypoint generation system can identify a new keypoint corresponding to a new leg-area landmark, such as an ankle or foot landmark, which can be used to augment or update the first set of keypoints. The keypoint generation system can generate a first point (e.g., midpoint) between a right hip landmark and a left hip landmark of the first set of keypoints, generate a first segment based on the first point and a horizontal extremity point of the second set of keypoints, generate a second segment based on a knee landmark and a vertical extremity point of the second set of keypoints, and select the new keypoint to correspond to a determined intersection of the first segment and the second segment. In some examples, the keypoint generation system can generate a first segment based on the first point (e.g., hip segment midpoint) and a line parallel to the horizontal axis, generate a second segment based on a knee landmark and a horizontal extremity point of the second set of keypoints, and select the new keypoint to correspond to a determined intersection of the first segment and the second segment.

In some examples, the keypoint generation system is integrated into a computing system or platform that generates personalized recommendations for users and/or delivers such personalized recommendations to a user during or between physical activity sessions. The computing system can thus deliver personalized, context-aware, and engaging feedback to users.

For example, upon a user initiating a session, the computing system can greet the user, and/or instruct the user to perform a physical activity. As the session progresses, the computing system can provide real-time feedback during and/or after each exercise. The feedback can be based on tracking and/or assessing the user's movements. In some examples, the feedback is followed by generating appropriate responses that guide the user through the correct execution of exercises and/or provide encouragement and constructive feedback. The end of the session can be marked by an end-of-session message. This message can serve as a review of the user's performance throughout the session, highlighting achievements and areas for improvement. In one illustrative example, the computing system can correspond to a digital therapy platform that includes a patient management system responsible for generating personalized recommendations, and a patient messaging system responsible for interacting with patients to increase the effectiveness of sessions by supporting and correcting them throughout their therapeutic exercises.

Examples in the present disclosure thus describe a keypoint generation system for enhanced motion tracking. By augmenting pose estimation models with a segmentation-based approach, the system generates additional keypoints for more accurately assessing a wide range of physical activities. In some examples, the system combines initial keypoints from pose estimation, body contour points from segmentation models, and keypoint generation logic to create a more comprehensive or accurate set of tracking points, enabling more precise movement analysis and feedback generation. Accordingly, examples in the present disclosure address or alleviate the technical problem of how to improve motion tracking accuracy.

This integrated approach may allow for the generation of keypoints that are not typically captured or consistently localized by standard pose estimation models. Examples described herein can thus address or alleviate the technical problem of inadequate or insufficient keypoints in the context of a pose estimation model.

The keypoint generation system can be used in conjunction with a motion tracking component of a computing system or platform for one or more of a variety of use cases. For example, the computing system can correspond to a wellness-related or fitness-related platform (e.g., a digital therapy platform, a system for analyzing athletes' movements in sports analysis and training applications, etc.), to a motion capture system for animation in film and video game production, to a workplace safety-related platform (e.g.. analyzing workers' movements for ergonomics and safety applications helping to identify and prevent repetitive strain injuries, etc.), among others. Additional use cases can include enhancing avatar control and interaction with improved body tracking in virtual reality (VR) and augmented reality (AR) applications, helping to improve human-robot interaction with improved robot response to human presence in collaborative environments, and so forth.

In some examples, the keypoint generation system is designed to adapt to specific physical activities, ensuring that the generated or identified keypoints are directly relevant to monitoring and assessing the performance of particular movements. For example, the system can generate additional keypoints to be tracked for back movements in exercises like the cat-cow pose, or generate new or updated foot or ankle landmarks for activities such as a quadricep stretch. This adaptability allows for more accurate and/or relevant motion tracking data tailored to the specific requirements of various physical therapy exercises or movements. Accordingly, examples in the present disclosure address or alleviate the technical problem of how to enable a motion tracking system to adapt effectively to different physical activities.

Furthermore, the keypoint generation system may enable improved motion tracking capabilities that allow a computing system to provide real-time, personalized feedback to users. The keypoint generation system enables the tracking of an enhanced set of keypoints across a series of images or video frames, generating motion tracking data that is then used to assess the quality and accuracy of the user's movements. Thus, a platform such as a digital therapy platform can offer timely, contextually relevant feedback, including, for example, corrective cues and performance assessments, which can be presented to a user through various UI elements including, but not limited to, natural language instructions, completion indicators, and rating visualizations. This real-time feedback mechanism significantly enhances the effectiveness and interactivity of digital therapy sessions. Examples described herein can thus address or alleviate the technical problem of how to improve a system's ability to provide real-time, personalized feedback in a digital therapy context.

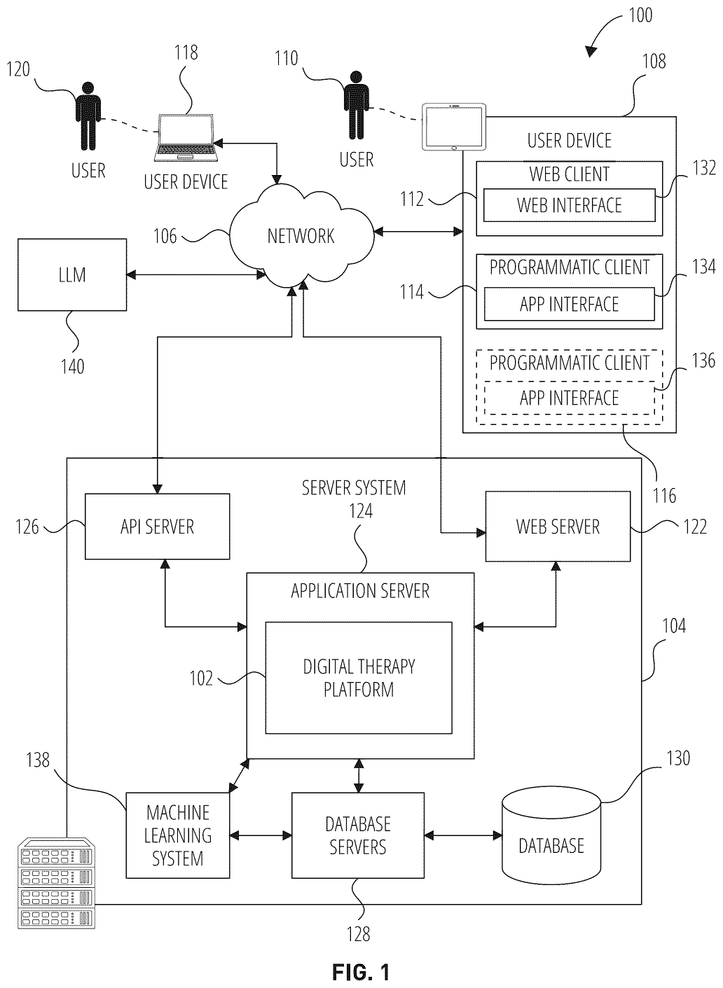

### Networked Computing Environment 100 (FIG. 1)

FIG. 1 is a diagrammatic representation of a networked computing environment 100 in which some examples of the present disclosure may be implemented or deployed. One or more servers in a server system 104 provide server-side functionality via a network 106 to a networked device, in the example form of a user device 108 that is accessed by a first user 110 (for example, a patient). A web client 112 (e.g., a browser) or a programmatic client 114 (e.g., an “app”) may be hosted and executed on the user device 108. In some examples, the user device 108 executes further web clients or programmatic clients, such as the programmatic client 116 shown in broken lines in FIG. 1.

The one or more servers in the server system 104 also provide server-side functionality via the network 106 to a user device 118 of a second user in the example form of a user 120. For example, the user 120 can be a physical therapist who assists user 110 with therapy via one or more digital channels. The networked computing environment 100 may thus include a device of a patient and a device of a therapist. Although not shown in FIG. 1, the user device 118 may include a web client or a programmatic client similar to the web client 112 or programmatic client 114 (or the programmatic client 116) of the user device 108.

An Application Programming Interface (API) server 126 and a web server 122 provide respective programmatic and web interfaces to components of the server system 104. An application server 124 hosts or provides, in an illustrative example, a digital therapy platform 102, which may also be referred to as a digital therapy system, and which includes subsystems, components, modules, or applications. While the digital therapy platform 102 is used below as an illustrative example of a computing system integrating a keypoint generation method and system described herein, other computing systems and/or platforms can be incorporated into the networked computing environment 100 in order to accommodate alternative or additional use cases, as previously detailed (e.g., animation motion capture systems, VR/AR applications, human-robot interaction platforms, and so forth).

The user device 108 and the user device 118 can each communicate with the application server 124, for example, via the web interface supported by the web server 122 or via the programmatic interface provided by the API server 126. It will be appreciated that, although a single user device 108 of the user 110 and a single user device 118 of the user 120 are shown in FIG. 1, a plurality of other user devices may be communicatively coupled to the server system 104 in some examples. In an illustrative example of a digital therapy platform, multiple patients may use their respective user devices to access the digital therapy platform 102, and multiple therapists may use their respective user devices to access the digital therapy platform 102.

Further, while certain functions are described herein as being performed at either a user device (e.g., web client 112 or programmatic client 114) or the server system 104, the location of certain functionality either within a user device or the server system 104 may be a design choice. For example, it may be technically preferable to deploy particular technology and functionality within the server system 104 initially, but to migrate this technology and functionality to a programmatic client at a later stage (e.g., when the user device has sufficient processing capacity).

The application server 124 is communicatively coupled to one or more database servers 128, facilitating access to one or more information storage repositories (e.g., a database 130). In some examples, the database 130 includes storage devices that store information to be processed or transmitted by the digital therapy platform 102.

The application server 124 accesses application data (e.g., application data stored by the database servers 128 or database 130) to provide one or more applications to the user device 108 and the user device 118 (e.g., via a web interface 132 or an app interface 134).

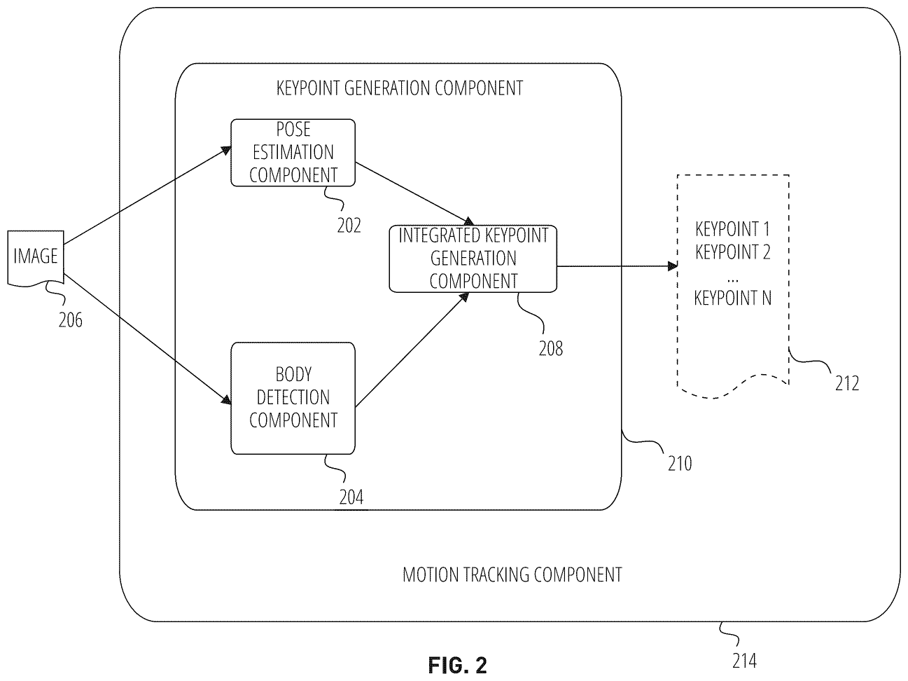

The digital therapy platform 102 is an illustrative example of a computing system or platform that incorporates motion tracking functionality including the keypoint generation system and method disclosed herein (see, e.g., FIG. 2-FIG. 4). The digital therapy platform 102 may provide a digital therapy application, or multiple digital therapy applications, to be accessible via the user device 108 or the user device 118. For example, the user 110 accesses a user portal of the digital therapy application to utilize various functionality, such as consulting virtually with the user 120, receiving a customized digital therapy program, receiving details of exercises to perform, interacting with the digital therapy platform 102 (e.g., providing input and receiving feedback messages), and reviewing educational content, while the user 120 may access a therapist portal of the digital therapy application to utilize various functionality, such as consulting virtually with the user 110, accessing a therapy workflow in a patient management user interface, tracking and managing patients.

Where multiple digital therapy applications are provided, different aspects of digital therapy can be provided via the respective applications. In some examples, a first application (e.g., the programmatic client 114) is a mobile application that provides an app interface (e.g., the app interface 134) for educational videos, cognitive behavioral therapy (CBT), and a communication channel with therapists, while a second application (e.g., the programmatic client 116) is a tablet application that provides access to exercises and an app interface (e.g., the app interface 136) for such purposes. The digital therapy application is referred to herein primarily as a single application for ease of reference and to facilitate understanding of aspects described herein. However, where this disclosure may refer to a single “digital therapy application” having certain functions, such functions may be performed by a single application or distributed across multiple applications. The digital therapy application, or applications, can be mobile applications, tablet applications, web applications, combinations thereof, or other types of applications.

To access the digital therapy application provided by the digital therapy platform 102, a user may create an account or access an existing account with a service provider associated with the server system 104 (e.g., a digital health services provider). The user 110 or the user 120 can, in some examples, access the digital therapy application using a dedicated programmatic client (e.g., the programmatic client 114 and/or 116), in which case some functionality may be provided client-side, and other functionality may be provided server-side.

Data stored in the database 130 can include various motion data, exercise data, performance data, and user data, such as demographic information, clinical history, and records collected from the user devices as well as through user interactions or user device interactions with assigned therapists or other users. It is noted that any biometric data or personally identifiable information (PII) is captured, collected, or stored upon user approval and deleted on user request. Whenever possible, the digital therapy platform 102 implements procedures that minimize the types and amount of user data that is collected and/or retained or analyzed. For example, as detailed in the disclosure herein, the digital therapy platform 102 uses computer vision techniques such as keypoint generation methods implemented by a keypoint generation component 210 of a motion tracking component 214 to identify and track only a set of keypoints for the body of a person. The set of keypoints corresponds to a schematic representation of the body, limiting the amount of potentially identifying detail collected and/or retained by the digital therapy platform 102. Furthermore, any collected data can be used for very limited purposes and for those purposes authorized by a user. To ensure limited and authorized use of biometric information or PII, access to this data is restricted to authorized personnel only, if at all. In addition, appropriate technical and organizational measures are implemented to ensure the security and confidentiality of this sensitive information.

The server system 104 may include multiple of the databases 130. Data stored in the database 130 or databases 130 may originate from various data sources. The data sources may include structured data and/or unstructured data. Data of the user 110 stored in the database 130 or databases 130 may include, for example, data describing a goal of the user (e.g., a therapy goal), data describing a baseline condition of the user, data describing changes in a condition of the user, motion data of the user, or performance data of the users related to one or more sessions (e.g., therapy session). Examples of the performance data include data relating to range of motion, pelvic floor muscle movement, exercise completion data, or movement accuracy.

The server system 104 may further host a machine learning system 138. The machine learning system 138 may implement one or more aspects of a machine learning pipeline (see, e.g., GLOSSARY). For example, the machine learning system 138 may include components enabled to train models based on historic user data, fine-tune models, or deploy models for inference. Various aspects of machine learning pipelines and other AI-related features are described further below.

The machine learning system 138 may leverage one or more machine learning models to perform functions as described herein, such as generating personalized recommendations for the user 110 (e.g., for review by the user 120), generating personalized messages for the user 110, or performing computer vision and tasks as described at least in FIG. 2. In some examples, the machine learning system 138 leverages one or more internally and/or externally hosted machine learning models (for example, the LLM 140 depicted in FIG. 1).

The machine learning models may include generative machine learning models, such as one or more Large Language Models (LLMs), or other language models. An LLM is a machine learning model trained on vast amounts of data to enable it to process inputs and generate language and, in some cases, other types of content to perform a wide range of tasks. An LLM is able to perform these functions due to its large number of parameters (e.g., billions) enabling it to capture, for example, patterns in language. In some examples, an LLM, which may be a foundation model such as GPT (Generative Pre-trained Transformer) or BERT (Bidirectional Encoder Representations from Transformers), serve as the core engine for natural language processing tasks within a digital therapy system. The machine learning system 138 leverages one or more foundation and/or fine-tuned LLMs to perform a variety of functions to support the operation of the digital therapy platform 102. These functions may include the generation of personalized recommendations to better manage therapy or personalized feedback for users, the interpretation of user input and queries, and the synthesis of complex medical data into comprehensible reports for healthcare providers.

The machine learning models may include models used in computer vision tasks, such as motion tracking, pose estimation, pose tracking and so forth. Such models may include Convolutional Neural Networks (CNNs) (e.g., ResNet-based architectures, Hourglass Networks such as Stacked Hourglass Networks, Mask R-CNN, etc.), Recurrent Neural Networks (RNNs) including Long Short-Term Memory (LSTM) networks or Gated Recurrent Units (GRUs), DeepLab models (e.g., DeepLabv3+), U-Net models, SegNet, Pyramid Scene Parsing Network (PSP), Transformer models such as Vision Transformer (ViT), Spatial Transformer Networks, Graph Convolutional Networks (GCNs), Optical Flow models such as FlowNet or PWC-Net, OpenPose, PoseNet, AlphaPose, DeepPose, DensePose, YOLO-Pose, SimpleBaseline, Mask R-CNN, MoveNet, BlazePose by Google™, the system described in “Reconstructing 3D Human Pose from 2D Image Landmarks”, VoxelPose, VIBE (Video Inference for Human Body Pose and Shape Estimation), Multi-person Pose Estimation models and/or techniques such as Associative Embedding or PersonLab, and so forth. For example, the keypoint generation component 210 described in FIG. 2 can make use of a pose estimation model such as BlazePose by Google™ or another pose estimation model, as well as a segmentation model such as Mask R-CNN, among others.

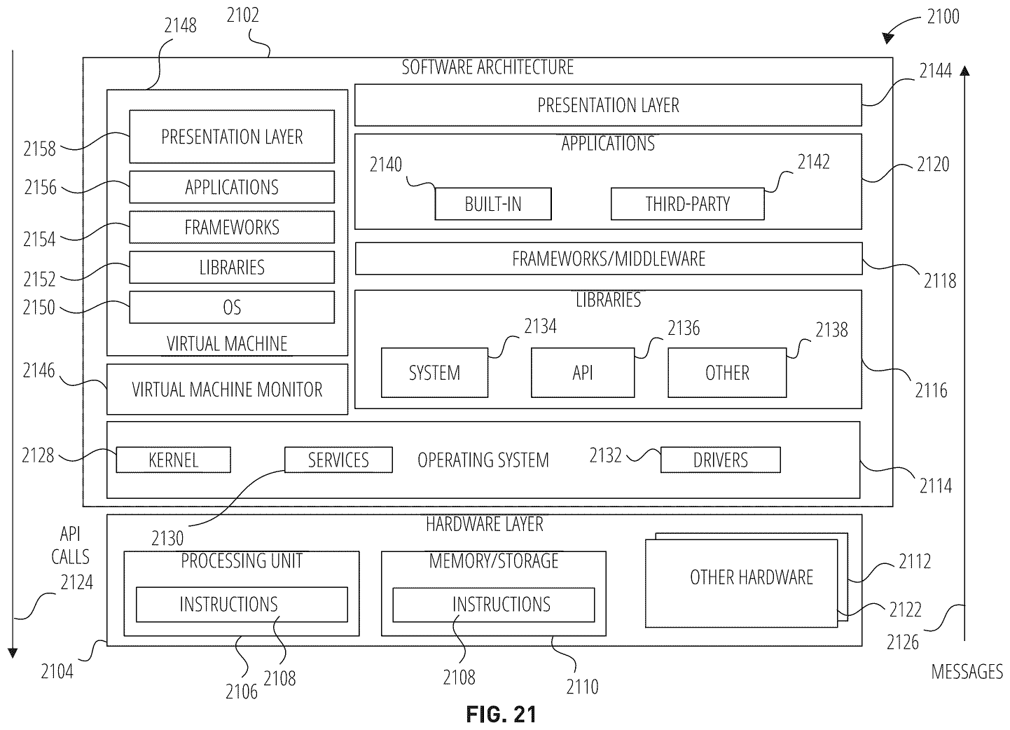

One or more of the application server 124, the database servers 128, the API server 126, the web server 122, the digital therapy platform 102, or part thereof, may each be implemented in a computer system, in whole or in part, as described below with respect to FIG. 21. In some examples, third-party applications can communicate with the application server 124 via the programmatic interface provided by the API server 126 (or via another channel).

For example, a third-party application may support one or more features or functions on a website or platform hosted by a third party, or may perform certain methodologies and provide input or output information to the application server 124 for further processing or publication. For example, the application server 124 may utilize functionality of machine learning models that are hosted by servers external to the server system 104.

The network 106 may be any network that enables communication between or among machines, databases, and devices. Accordingly, the network 106 may be a wired network, a wireless network (e.g., a mobile or cellular network), or any suitable combination thereof. The network 106 may include one or more portions that constitute a private network, a public network (e.g., the Internet), or any suitable combination thereof.

### Keypoint Generation Component 210 (FIG. 2)

FIG. 2 is a block diagram that illustrates a keypoint generation component 210 as part of a motion tracking component 214, according to some examples. The keypoint generation component 210 is shown to include a pose estimation component 202, a body detection component 204, and an integrated keypoint generation component 208. In some examples, the keypoint generation component 210 can include one or more additional components. In some examples, the shown components and/or the additional components can share functionality, or be part of alternative arrangements or interactions. In some examples, the motion tracking component 214 can be a part of, or connected to, the digital therapy platform 102. In some examples, one or more of the components of the keypoint generation component 210 can be executed at the user device 108 (e.g., on-device execution), at the server system 104, and so forth. For example, both the body detection component 204 and the pose estimation component 202 can be executed at the user device 108.

Given an image of a person (e.g., image 206) the keypoint generation component 210 generates a set 212 of keypoints corresponding to one or more body regions or parts of the person and/or other points that are informative in the context of a given physical activity. Image 206 can illustrate one or more areas of a person's body, where an area can correspond to the whole body, or a portion or subset of the body. While the disclosure herein discusses examples of a body of a person, similar techniques can be used for applications that require tracking and/or assessing movements performed by animals (e.g., as part of therapeutic interventions, scientific research, and so forth). As seen below, the keypoint generation component 210 can generate set 212 of keypoints using a predetermined function, as implemented by the integrated keypoint generation component 208. As mentioned previously and further detailed below, keypoint identification or generation can include keypoint selection (e.g., selecting among body contour keypoints, etc.) and/or keypoint production (e.g., producing new keypoints based on information provided by the pose estimation component 202 and/or body detection component 204). In some examples, the motion tracking component 214 uses the keypoint generation component 210 to execute the keypoint identification or generation steps described below for one or more of a series of images, such as video frames. Thus, the keypoint generation component 210 can enable the tracking of the third set 212 of keypoints throughout the series of images or video frames, helping generate motion tracking data for the respective person.

In some examples, the keypoint generation component 210 generates a first set of keypoints using a pose estimation component 202 that processes the image 206 or a portion thereof using a pose estimation model. Given an image of a person, such as a video frame, keypoint-based pose estimation can include identifying and/or localizing a set of keypoints or landmarks corresponding to important body parts. These keypoints can include head region features or facial features (e.g., ears, eyes, mouth, or nose), joint features (e.g., shoulders, elbows, wrists, hips, knees, ankles, or fingers), and so forth. Pose tracking extends the concept of pose estimation by following these keypoints across multiple frames and/or localizing them in the respective frames, contributing to the analysis of human motion over time (see GLOSSARY section for more details on pose estimation and/or tracking).

The pose estimation component 202 can employ one or more pose detection and/or pose regression models, as made available by frameworks, APIs, or systems such as OpenPose, PoseNet, AlphaPose, DeepPose, DensePose, YOLO-Pose, Mask R-CNN, MoveNet, TensorFlow Pose estimation, MediaPipe Pose, BlazePose by Google™, and so forth. In some examples, pose estimation component 202 uses a keypoint-based pose detection and/or keypoint-based pose regression model.

Many pose estimation and/or tracking models are keypoint-based pose estimation and/or tracking models that employ a limited set of keypoints (e.g., the BlazePose model uses 33 such keypoints) focused on head region keypoints (e.g., facial features, ears, etc.) and/or body joints, as mentioned above. While such keypoints are often sufficient, certain physical activity movements require tracking parts of the body that may not correspond to available joints or key facial features as described above. For example, movements of the back such as back bending or back extensions require, or can benefit from, identifying and tracking points on a person's back. Furthermore, identifying keypoint locations in an image can be difficult in the case of certain poses less expected by the pose estimation model, leading to keypoints not being detected or being incorrectly localized. Examples of such keypoints may include ankle, foot or toes landmarks, hand keypoints (e.g., finger-related keypoints for a thumb, index, pinky, hand palm keypoints, etc.), and so forth.

A computing system or application that tracks and assesses a physical activity or movement using a set of keypoints lacking landmarks representative of certain areas of the body and/or lacking keypoints relevant to the specific activity or movement may generate incomplete or suboptimal measurements and/or assessments. Furthermore, a computing system or application that uses noisy keypoints for motion tracking may generate noisy measurements and/or assessments associated with the execution of the person's movements. Thus, the keypoint generation component 210 implements a strategy for updating the first set of keypoints based on further processing of the image 206, in order to augment and/or update the keypoints available for motion tracking.

In some examples, the keypoint generation component 210 uses a body detection component 204 to determine, by processing image 206 or a portion thereof, a body mask indicating how likely one or more image areas are to correspond to a person's body. In some examples, the body detection component 204 can use a trained ML model to process image 206 or a portion thereof and generate a body mask in the form of a segmentation mask (e.g., see a description of a segmentation mask and/or its further processing below). In some examples, a pose estimation model such as the one used by the pose estimation component 202 can be additionally used, with an appropriate parametrization, to produce a body mask represented, for example, by a segmentation mask. Alternatively, the body detection component 204 can use a separate trained ML model to produce the body mask (e.g., a segmentation mask). In some examples, a body mask generated by the body detection component 204 can be generated based on an aggregation of multiple masks, corresponding for example to segmentation masks associated with detected limbs and/or other body parts. In some examples, the body detection component 204 can generate, for example using a trained ML model, a square, rectangle or other shape that surrounds the subject (i.e. a bounding box). The region enclosed by bounding box and/or the bounding box itself can be further used in the production of a body mask. In some examples, the bounding box can be used as a source of additional potential keypoints in the absence of, or as an alternative to, a segmentation mask or to a contour mask. The bounding box can be constructed, in some examples, based on an aggregation of bounding boxes corresponding to body limbs and/or body parts. In the following, the example of a body mask represented by a segmentation mask is used throughout for illustrative purposes only identifying body contour points and/or additional keypoints can be performed based on any of the above body mask examples.

In some examples, given the image 206, a segmentation mask generated by the body detection component 204 corresponds to a set of pixels, each pixel associated with an indicator of how likely the pixel is to be part of the body of the person detected in the image. For example, the segmentation mask can correspond to a segmentation_mask_matrix: matrix (H, W), where H corresponds to the height (in pixels) for an input image (e.g., image 206), and W corresponds to the width (in pixels) for the image. In some examples, each matrix entry, associated with a specific image pixel, corresponds to a probability of the specific pixel being representative of the person's body. For example, a pixel determined to be part of the body or near the body will have a corresponding associated probability of 1 or a value close to 1. Pixels determined to be farther away from the body have lower probabilities, potentially decreasing to 0. In some examples, the segmentation mask can be represented by a grayscale frame, where pixel values of K₁ (e.g., K₁=0) correspond to pixels determined to be outside the body, pixel values of K₂ (e.g., K₂=256) correspond to pixels determined to be inside the body, and pixel values in the (K₁, K₂) interval correspond to pixels determined to indicate the contour of the body. In some examples, the segmentation mask can be represented using a RGB frame, where one or more of the three channels have the same scale: pixel values of K₁ (e.g., K₁=0) correspond to pixels outside the body, pixel values of K₂ (e.g., K₂=256) to pixels inside the body, and pixel values in the (K₁, K₂) interval correspond to pixels indicating the contour of the body.

Given a body mask (e.g., segmentation mask, etc.) generated by the body detection component 204, the keypoint generation component 210 can further process the body mask (e.g., segmentation mask) to identify points corresponding to the contour of the person's body. The integrated keypoint generation component 208 can then use such body contour keypoints together with the keypoints generated by the pose estimation component 202 to generate an updated set 212 of keypoints for improved tracking of the person's movements. In some examples, the integrated keypoint generation component 208 can select one or more of the body contour keypoints for inclusion in the updated set 212 of keypoints. In some examples, the integrated keypoint generation components 208 can produce keypoints based on the information provided by the body contour keypoints and/or the keypoints generated by the pose estimation component 202.

In some examples, identifying body contour points based on the available segmentation mask corresponds to filtering the segmentation mask pixels based on their associated indicator values with respect to a predetermined criterion, such as determining that the indicator values fall within a predefined range (e.g., a probability value range, or a range of values between 0 and 256 for the grayscale frame case, etc.). For example, given segmentation mask pixels with associated probabilities, determining the body contour points can be implemented as determining the segmentation mask pixels whose associated probabilities fall within a [M, N] range, where M and N are predetermined constants (e.g., [0.3, 0.6]). The choice of the minimum range value and maximum range value ensures that the pixels are in-between the outside of the body (e.g., associated with a probability value of 0) and the inside of the body (e.g., associated with a probability value of 1). In some examples, the keypoint generation component 210 can thus process a segmentation_mask_matrix whose entries correspond to probabilities, and generate a contour_mask_matrix: matrix (H, W), where the contour mask matrix entries are set to 1 for the pixels or points inside the target predefined range (e.g., body contour points) and to 0 for points outside the target predefined range (non-contour points). In some examples, other indicator values can be used to indicate points inside the target predefined range and/or outside the target predefined range. Thus, the keypoint generation component 210 can produce a second set of keypoints corresponding to body contour points for the body of the person detected in image 206. The filtering of the segmentation mask can be performed by the body detection component 204, or by a separate body contour detection component (or subcomponent of 204).

Given a first set of keypoints (e.g., generated by the pose estimation component 202), and/or a second set of keypoints corresponding to the body contour (e.g., generated by the body detection component 204), the integrated keypoint generation component 208 generates, using a predetermined keypoint identification or generation function, a third set 212 of keypoints corresponding to a more comprehensive and/or accurate set of keypoints for the body of the person. In some examples, the predetermined function identifies or generates one or more keypoints by selecting among input keypoints (e.g., selecting one or more of keypoints of the second set of keypoints). In some examples, the predetermined function produces one or more entirely new keypoints, based on at least the information provided by the first and/or second set of keypoints. In some examples, identifying or generating keypoints can take into account a physical activity of interest, ensuring the generated keypoints will help track and/or assess the performance of the physical activity. In some examples, the third set 212 of keypoints can be initialized with one or more of the keypoints in the first set of keypoints that incorporates original keypoints or landmarks produced by the pose estimation component 202. The generated keypoints can be added as new elements to the third set 212 of keypoints, augmenting the available keypoints or landmarks for tracking. Additionally or alternatively, a generated keypoint can correspond to a higher-quality estimate for a keypoint in the first set of keypoints, and can be used to replace it during the generation of the third set 212 of keypoints. In some examples, the third set 212 of keypoints can be initialized as an empty set, and only one or more of the generated keypoints can be added to it (for example, in a case where only a small set of newly generated keypoints are to be used in tracking a specific area or sub-movement). In some examples, the one or more newly generated keypoints can be selected from among the elements of the second set of keypoints (e.g., body contour points) such that at least a majority of the elements of the second set of keypoints are selected as newly generated keypoints and subsequently added to the third set 212 of keypoints. In some examples, almost all or all of the elements of the second set of keypoints are identified as newly generated keypoints to be added to the third set 212 of keypoints.

In some examples, the integrated keypoint generation component 208 identifies an area or region of interest in image 206, and determines a set of intermediate points in the respective area. The area and/or intermediate points can be generated based on one or more of the keypoints in the first set of keypoints such as, for example, joint keypoints generated by the pose estimation component 202. The integrated keypoint generation component 208 computes, for each keypoint in the second set of keypoints (e.g., body contour keypoints), a value of a predetermined measure based on the respective keypoint, the set of intermediate points and/or the set of first keypoints. The body contour keypoint whose associated value optimizes one or more predetermined ranking and/or selection criteria is retained as a new keypoint to be included in the final, third set of keypoints used for tracking the person's movements. The predetermined measure can take into account intermediate points, or be computed using only one or more of the keypoints in the first set of keypoints. For example, the integrated keypoint generation component 208 can select body contour keypoints from the second set of keypoints based on an estimated distance between each such body contour keypoint and at least one keypoint of the first set of keypoints. In some examples, the procedure for generating intermediate points, the predetermined measure, and/or the selection criteria for new keypoints can be associated with specific physical activities, such as movements of the back, movements involving the stretching of the neck, a quadricep stretch and other movements involving leg stretching, and so forth.

In some examples, generating the set of intermediate points includes generating a segment based on two or more landmarks retrieved from the first set of keypoints (e.g., shoulder and hip landmarks and/or corresponding shoulder midpoints or hip midpoints, hip and knee landmarks, and so forth). The predetermined measure can correspond, for example, to a distance measure based on each keypoint of the second set of keypoints and one or more points on the generated segment or an extension of the generated segment. In an illustrative example for computing such a predetermined measure, the keypoint generation component 210 can generate a reference vector using at least the generated segment and for each keypoint of the selection of the second set of keypoints, generate a candidate vector based on the keypoint and a keypoint of the segment. The keypoint generation component 210 can then compute a keypoint-associated indicator value based on the two vectors, where the indicator value can correspond to the angle between the two vectors, the dot product of the two vectors, or other measures based on at least the two vectors. In some examples, selecting the new keypoint includes selecting a keypoint of the second set of keypoints associated with an indicator value (e.g., an angle) of a set of computed indicator values associated with the second set of keypoints, wherein the indicator value satisfies a predefined selection criterion (e.g., minimum angle of a set of angles, maximum dot product value of a set of dot product values, etc.).

In some examples, selecting the new keypoint can correspond to selecting the keypoint of the second set of keypoints that is closest to the extension of the generated segment. In some examples, the keypoint generation component 210 can generate new keypoints using the intersection of a body contour detected in a frame and a computed extension of a body limb representation represented by a plurality of previously identified keypoints or landmarks from the first set of keypoints. The intersection computation can compute the body contour pixel with the shortest distance to the computed extension line for the respective body limb.

In some examples, a body contour pixel or keypoint that optimizes (e.g., minimizes or maximizes) a distance to one or more other landmarks or keypoints of the first set of keypoints can be selected as a newly generated keypoint.

In some examples, generating the new keypoint is based on a plurality of segments, each segment based on a landmark of the first set of keypoints and either an additional landmark of the first set of keypoints or a body contour point. For example, a first segment can be generated based on at least a first landmark of the first set of keypoints and a first contour point of the second set of keypoints. A second segment can be generated based on at least a second landmark of the first set of keypoints and a second contour point of the second set of keypoints. Given the two segments, selecting the new keypoint corresponds to an intersection of the first segment and the second segment.

In some examples, any of the keypoint identification procedures disclosed herein that examine and/or select among keypoints from the second set of keypoints can select among a subset of the second set of keypoints, based on an apriori or online filtering step that excludes from consideration some keypoints in the second set of keypoints.

Two example scenarios of the keypoint generation component 210 are further detailed herein in connection with two physical activities, the cat-cow movement and the quadricep stretch, for illustrative purposes only. As detailed above, additional example embodiments of the keypoint generation component 210 can be used or adapted to address the generation of new keypoints independent of an activity of interest, or for a variety of other physical activities.

### Example: Cat-Cow Movement

In an illustrative example, the cat-cow activity or movement is performed sideways to the camera, with the person extending and/or flexing their back. Given the characteristics of this physical activity, facial keypoints or joint-related keypoints such as shoulder, hip or knee landmarks may be insufficient to track, measure and/or assess the movement of the person in order to offer meaningful form and/or execution feedback. To do so, it is useful to track the movement of the outer part of the person's back. While the operations below are described in the context of this illustrative example, one or more of these operations can be used to generate keypoints for other movements or physical activities.

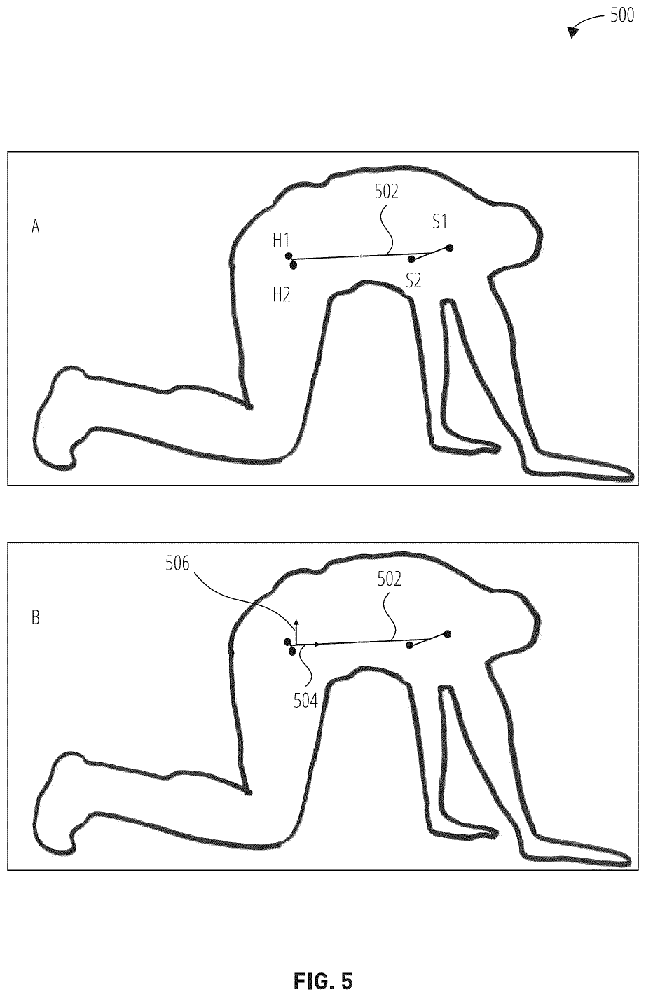

The keypoint generation component 210, for example using the integrated keypoint generation component 208, can generate additional keypoints to this end (see, for example, FIG. 5-FIG. 7). The keypoint generation component 210 can retrieve hip keypoints and shoulder keypoints from the first set of keypoints produced by the pose estimation component 202. The midpoint between the two hip keypoints or landmarks and the midpoint between the two shoulder keypoints or landmarks can be used to generate a segment connecting the hip region and the shoulder region. The keypoint generation component 210 can determine one or more intermediate points based on this segment, such as a mid-point, or N equidistant points, with N being a constant (e.g., N=3 equidistant points).

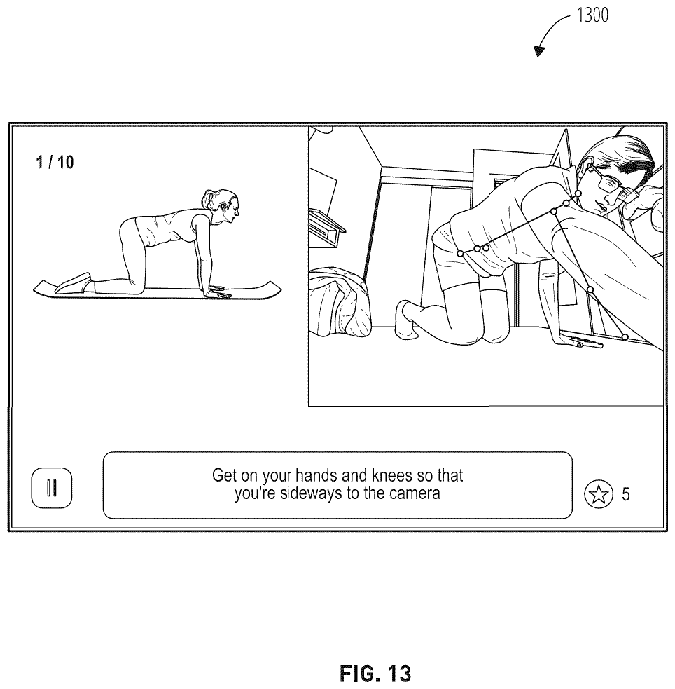

The keypoint generation component 210 generates an intermediate keypoint of the segment (e.g., the midpoint) and uses it to identify a corresponding new keypoint on the contour of the body by selecting from the second set of keypoints as described below. The keypoint generation component 210 generates a first vector corresponding to the generated segment and a back orthogonal vector corresponding to a second vector orthogonal to the first one. It then generates a set of candidate vectors, each candidate vector based on the intermediate keypoint (e.g., the segment midpoint) and a candidate body contour keypoint from the second set of keypoints. The keypoint generation component 210 computes and/or ranks angles between the candidate vectors and the back orthogonal vector, selecting the candidate vector with the minimum angle. The candidate body contour keypoint associated with the selected candidate vector is selected as a new keypoint, to be added to a third set of keypoints initialized using some or all of the first set of keypoints or landmarks. As indicated above, keypoint generation component 210 can generate one or more intermediate keypoints and/or select one or more corresponding body contour keypoints (see, for example the set of newly identified body contour keypoints in FIG. 13 through FIG. 20). The third set 212 of keypoints corresponds to the set of keypoints used for the motion tracking and assessment capabilities of the digital therapy platform 102 (see, for example, FIG. 13 through FIG. 20).

### Example: Quadricep Stretch

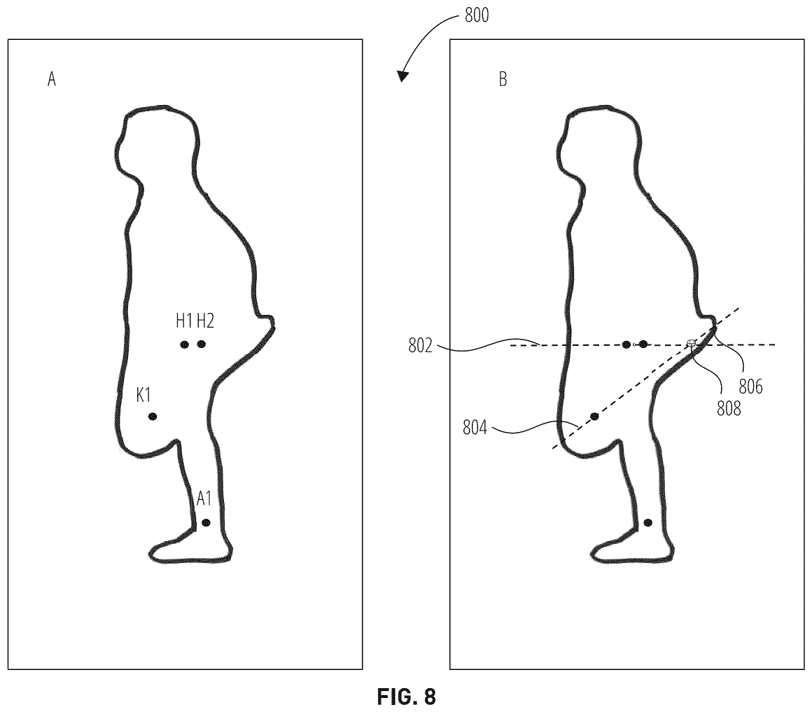

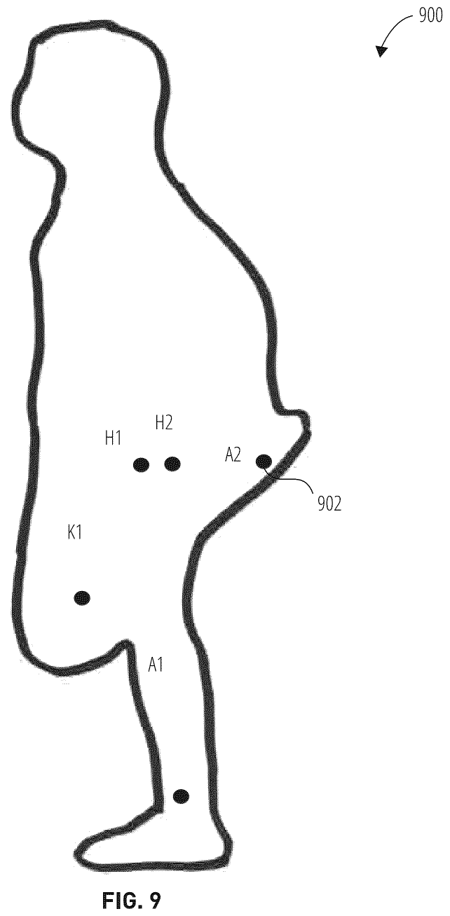

In another illustrative example, the keypoint generation component 210 can accommodate positions not expected by a pose estimation model, such as for example, a pose corresponding to a quadricep stretch. A pose that includes a person's foot being placed on the person's backside can lead to suboptimal tracking of keypoints or landmarks corresponding to an ankle, foot, or toes. In this illustrative example, the keypoint generation component 210 can generate a new keypoint corresponding to a foot or ankle landmark, which can be used to augment or update the first set of keypoints (see, for example, FIG. 8 and FIG. 9). While the operations below are described in the context of this illustrative example, one or more of these operations can be used and/or combined to generate keypoints for other movements or physical activities.

The keypoint generation component 210 can generate an intermediate point (e.g., midpoint) between a right hip landmark and a left hip landmark of the first set of keypoints, and generate a first segment based on the intermediate point. The first segment can be further based on one of the horizontal or vertical axis and/or a preselected angle (e.g., a horizontal line through the intermediate keypoint, a line through the intermediate keypoint at a preselected angle with respect to the horizontal or vertical axis, etc.). In some examples, the first segment can be based on the intermediate keypoint and an extremity point of the second set of keypoints. For example, a horizontal extremity point can correspond to a keypoint in the second set of keypoints with a maximum horizontal axis coordinate of the second set of keypoints (similarly, a vertical extremity point can correspond to a keypoint in the second set of keypoints with a maximum vertical axis coordinate of the second set of keypoints). In some examples, extremity points can be selected using minimum rather than maximum coordinate values.

The keypoint generation component 210 can generate a second segment based on a landmark (e.g., a knee landmark), and an extremity point of the second set of keypoints (e.g., a horizontal extremity point). The keypoint generation component 210 can select the new keypoint to correspond to a determined intersection of the first segment and the second segment. The newly generated keypoint can be added to the third set 212 of keypoints as a new element, or a replacement for a lower-quality, previously located foot or ankle landmark.

As noted above, the digital therapy platform 102 can use the third set 212 of keypoints, localized across a series of images or video frames, to track and assess the movements of a person, in order to provide real-time cues or feedback to the person (see, for example, FIG. 13 through FIG. 20).

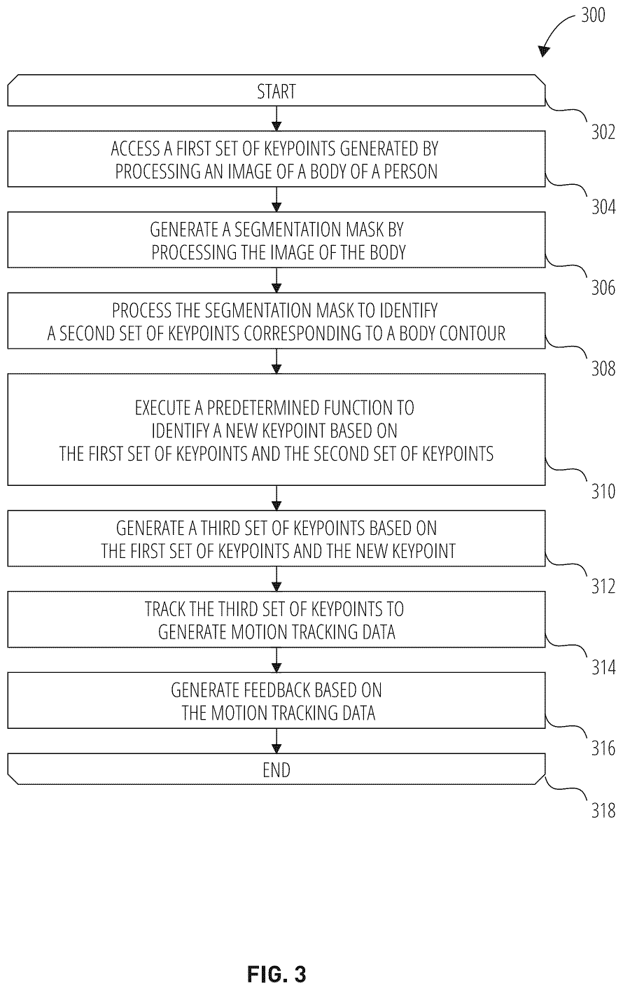

### Keypoint Generation Method 300 (FIG. 3)

FIG. 3 illustrates a method 300 for generating new keypoints, according to some examples, as performed by the keypoint generation component 210. The method 300 can be performed by the digital therapy platform 102 or a device or system coupled to the digital therapy platform 102. For example, the method 300 is performed at the user device 108. The method 300 commences at opening loop element 302, and proceeds to operation 304, where the keypoint generation component 210 accesses a first set of keypoints generated by processing at least one image of a body of a person. At operation 306, the keypoint generation component 210 generates a segmentation mask by processing the at least one image of the body. At operation 308, the keypoint generation component 210 processes the segmentation mask to identify a second set of keypoints corresponding to a body contour of the body.

The method 300 proceeds to operation 310, where, in response to identifying the second set of keypoints, the keypoint generation component 210 executes a predetermined keypoint identification or generation function to identify a new keypoint based on the first set of keypoints and the second set of keypoints. At operation 312, the keypoint generation component 210 generates a third set of keypoints based on the first set of keypoints and the new keypoint. At operation 314, the keypoint generation component 210 tracks the third set of keypoints to generate motion tracking data. At operation 316, the keypoint generation component 210 generates feedback based on the motion tracking data.

As mentioned, in some examples, the third set of keypoints is tracked while the person performs a physical activity. The method 300 may include presenting, at a UI (e.g., at the user device 108), an instruction to the person for performing the physical activity. Furthermore, the method 300 may include providing the feedback to the person in real-time via the UI. The method 300 concludes at closing loop operation 318.

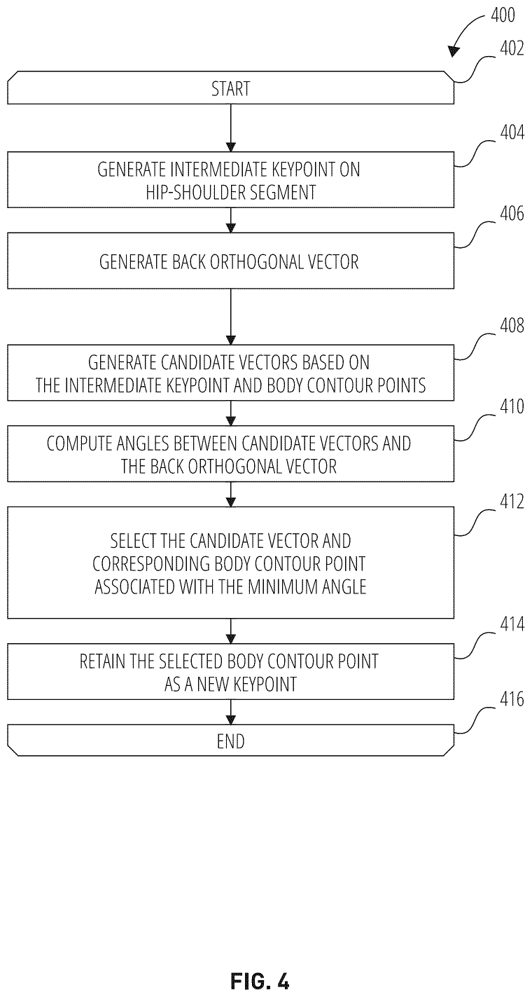

### Keypoint Generation Method 400 for Back Movements (FIG. 4)

FIG. 4 illustrates a method 400 for generating a new keypoint in the context of a movement of the back, according to some examples, as performed by the keypoint generation component 210 using components shown in FIG. 2.

The method 400 commences at opening loop element 402, and proceeds to operation 404, where, given a first set of keypoints generated by the pose estimation component 202 for a current image, the keypoint generation component 210 retrieves right hip and left hip landmarks as well as shoulder landmarks from the first set of keypoints. The keypoint generation component 210 uses the midpoint between the hip landmarks (e.g., hip_midpoint_landmark, characterized by a set of (X, Y, Z) coordinates) and the midpoint between the shoulder landmarks (e.g., shoulder_midpoint_landmark, characterized by a respective set of (X, Y, Z) coordinates) to generate a hip-shoulder segment. The keypoint generation component 210 then generates an intermediate keypoint on the respective segment, such as for example the midpoint of the hip-shoulder segment, characterized by a set of (X, Y, Z) coordinates.

At operation 406, the keypoint generation component 210 generates a first vector associated with the segment and a second vector orthogonal to it, denoted for example by back_orthogonal_vector.

At operation 408, the keypoint generation component 210 retrieves a second set of keypoints corresponding to body contour points as generated by the body detection component 204 after processing the current image. In some examples, the second set of keypoints is given by a contour_mask_matrix: matrix (H, W), computed as detailed in FIG. 2, where H corresponds to the height (in pixels) for the current image, W corresponds to the width in pixels for the current image, and the contour mask matrix entries are set to 1 for the pixels or points inside the target predefined range (e.g., body contour points) and to 0 for points outside the target predefined range (non-contour points). Each pixel or point with a corresponding contour mask matrix entry of 1 thus corresponds to a keypoint in the second set of keypoints. Given the second set of keypoints for the body contour, the keypoint generation component 210 generates candidate vectors based on one or more of the body contour keypoints and, respectively, the intermediate keypoint on the hip-shoulder segment.

At operation 410, the keypoint generation component 210 computes a list or set of angles, each angle being an angle between a candidate vector and the back orthogonal vector.

The list or set of angles is reranked based on the magnitude of the angle, and the minimum angle is selected together with the corresponding candidate vector and corresponding body contour point (see operation 412).

Finally, the selected body contour point is retained, at operation 414, as a new keypoint. In this example, the new keypoint corresponds to the middle of the back on the contour of the person's body. The keypoint generation component 210 can add the new keypoint to a third set of keypoints, for example in addition to the first set of keypoints. The third set of keypoints can then be used for tracking the back movement of interest across image frames.

The method 400 ends at closing loop element 416.

### Keypoint generation Example for Back Movements (FIG. 5-FIG. 7)

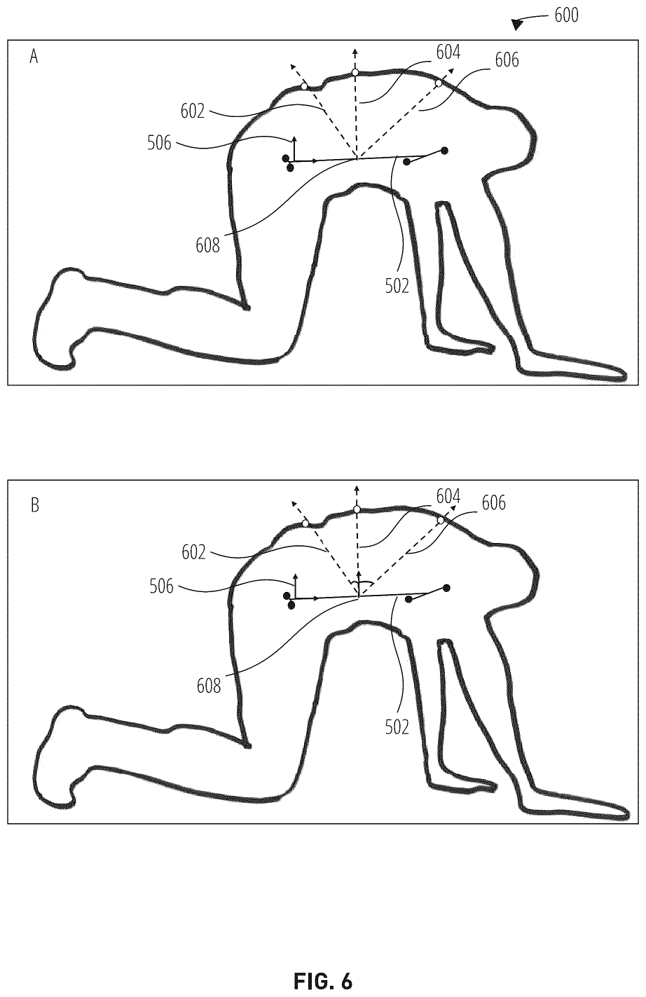

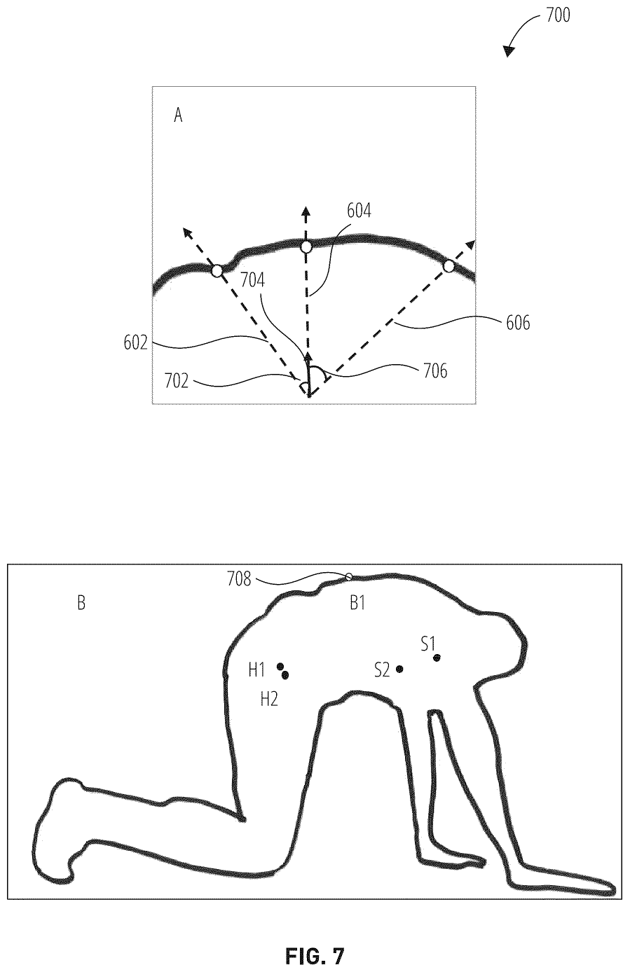

FIG. 5, FIG. 6 and FIG. 7 collectively illustrate a keypoint generation example for back movements, as implemented, for example, by the keypoint generation component 210 according to some examples. For example, the keypoint generation component 210 can use one or more operations of method 400, as described below.

Panel A in illustration 500 of FIG. 5 includes an example of a contour of a body, as generated, for example, by the contour detection functionality of body detection component 204 in FIG. 2. Panel A also includes examples of keypoints generated, for example, by the pose estimation component 202: H1 and H2 are examples of hip landmarks, S1 and S2 are examples of shoulder landmarks. Panel A also includes a segment 502 connecting the midpoint of the H1-H2 segment and the midpoint of the S1-S2 segment.

Panel B in illustration 500 of FIG. 5 includes an example of a vector 504 based on the segment 502, and a back orthogonal vector 506, derived for example as in method 400 (the labels of the hip and shoulder landmarks are omitted for readability only).

Panel A in illustration 600 of FIG. 6 includes an illustrative example of candidate vectors 602, 604, and 606. Each such candidate vector is generated using an intermediate keypoint (e.g., midpoint 608 of segment 502) and a candidate body contour point of a set of the body contour points, or of a pre-selected subset of the body contour points. As seen in Panel B in illustration 600 of FIG. 6 and Panel A of illustration 700, the keypoint generation component 210 can compute angles between the back orthogonal vector 506 and each of the candidate vectors (see, e.g., angle 702, 704 and 706), and rank the angles. The keypoint generation component 210 can select the smallest angle and/or within a predefined range (e.g., close to or equal to 0, etc.) as corresponding to a final selection of a candidate vector and candidate body contour point. Here, the keypoint generation component 210 selects the smallest angle 704 and candidate vector 604, corresponding to body contour keypoint 708 in illustration 700 in FIG. 7.

As seen in panel B of illustration 700 of FIG. 7, the keypoint generation component 210 can add the body contour keypoint 708, corresponding to a back keypoint B1, to the set of previously detected landmarks (here including, but not limited to, hip and shoulder landmarks). While illustration 700 showcases an example of a selection of a single keypoint of the body contour keypoints, the above operations and/or similar operations can be used to select additional keypoints of the body contour keypoints for addition to the set of previously detected landmarks (see, e.g., FIG. 2 for more details).

### Keypoint Generation Example for Quadricep Stretch (FIG. 8-FIG. 9)

FIG. 8 and FIG. 9 collectively illustrate a keypoint generation example for a quadricep stretch, as implemented, for example, by the keypoint generation component 210 according to some examples.

Panel A of illustration 800 of FIG. 8 illustrates a body contour as detected, for example, by the body detection component 204 as described in at least FIG. 2. The panel also illustrates example landmarks detected by the pose estimation component 202, such as an ankle landmark A1, a knee landmark K1, and hip landmarks H1 and H2 (other landmarks omitted for readability).

Panel B of illustration 800 also illustrates an extended segment 802 corresponding to a horizontal line through a midpoint of a hip landmark-connecting segment (connecting midpoint omitted for readability, together with the landmark labels from Panel A of illustration 800). Panel B of illustration 800 of FIG. 8 additionally illustrates an extended segment 804 connecting the example knee landmark K1 (label omitted for readability) with a body contour point 806 whose horizontal axis coordinate corresponds to a maximum coordinate value among the body contour points.

Panel B of illustration 800 additionally illustrates the intersection 808 of extended segments 802 and 804, corresponding to an additional leg landmark.

For example, as seen in illustration 900 of FIG. 9, the point of intersection 808 can correspond to an approximate foot or ankle keypoint A2 (see, e.g., element 902). The keypoint generation component 210 can add the newly detected keypoint A2 to the set of previously detected landmarks (here including, but not limited to, knee, hip and ankle landmark(s)).

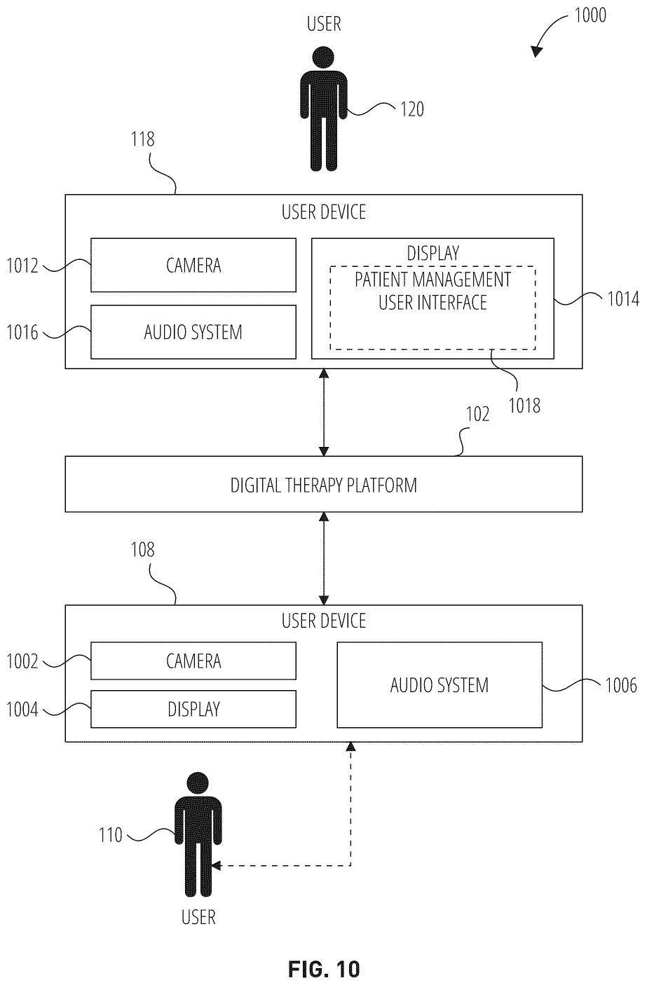

### Interaction Diagram 1000 (FIG. 10)

FIG. 10 shows an interaction diagram 1000 depicting interactions among the digital therapy platform 102 of FIG. 1, a user device of a therapist (e.g., a physical therapist), and a user device of a patient, according to some examples. In FIG. 10, the user device 118 of the user 120 of FIG. 1 and the user device 108 of the user 110 of FIG. 1 are shown for ease of reference. It will be appreciated that similar interactions may be performed with other user devices connected to the digital therapy platform 102. It will further be understood that only a few selected components of the user device 108 and the user device 118 are shown in FIG. 10 to describe certain functionality, and that the user device 108 and the user device 118 may include numerous other components.

As discussed with reference to FIG. 1, both the user device 108 and the user device 118 are computing devices that can communicate with the digital therapy platform 102 (e.g., by accessing a digital therapy application). The user device 108 and the user device 118 may, for example, be mobile phones, tablets, personal computers, or combinations thereof.

The user device 108 includes, or is connected to, a camera 1002, a display 1004, and an audio system 1006. The user device 108 further includes at least one processor, at least one memory, and a communication module (not shown) for communicating with the digital therapy platform 102 and one or more other devices.

The camera 1002 can capture images or video content of the user 110 performing exercises to allow tracking of user motion via computer vision techniques. For example, the disclosure herein describes methods for keypoint generation as implemented by a keypoint generation component 210 included in a motion tracking component 214 (see, e.g., at least FIG. 2, FIG. 4 or FIG. 13 to FIG. 20).

The camera 1002 and other components of the user device 108 (e.g., microphone, loudspeaker, and communication modules) may also facilitate virtual consultations. The user 110 may connect with the user 120 via the digital therapy platform 102, for example, to virtually consult with the user 120. The display 1004 is used to provide a user interface of the digital therapy platform 102, such as a user interface of the digital therapy application.

The audio system 1006 may, for example, include one or more microphones and one or more loudspeakers or modules for connecting to external microphones and/or loudspeakers. This enables the user 110 to provide input to the digital therapy platform 102 in audio format and to receive audio messages from the digital therapy platform 102.

The user 110 may, for example, enter patient data, such as demographic information, clinical history, and symptoms (e.g., identification of painful zones and pain levels), and the data is then transmitted to the digital therapy platform 102. The digital therapy platform 102 may generate (e.g., automatically or with assistance from the user 120) a digital therapy program and make it available to the user 110. For example, the digital therapy platform 102 can be a physical therapy program that guides the user 110 through an 8-week program or a 12-week program to treat or improve Lower Back Pain (LBP) or another MSK condition through targeted physical therapy (the actual duration may vary or be dynamic, for example, based on patient condition, engagement, or recovery trajectory).

As mentioned, in some examples, the camera 1002 can be used as part of a computer-vision based motion tracking functionality. Alternatively, or additionally, the user 110 may be equipped with trackers (not shown) on or in their body while performing the exercises forming part of the digital therapy program, including those designed for musculoskeletal rehabilitation or pelvic-floor therapy (merely as examples). Each tracker can include at least one sensor, for example, an inertial measurement unit. The inertial measurement unit of each tracker include one or more inertial sensors selected from, for example, an accelerometer, a gyroscope, or a magnetometer. Sensors may also include one or more force sensors. The inclusion of force sensors is particularly relevant for pelvic-floor therapy, where the measurement of exerted pressure during exercises can provide valuable feedback for the rehabilitation process. Each tracker may further include at least one processor, at least one memory, and a wireless communications module for communicating with the user device 108. For example, each tracker may transmit advertisement packages, data packets with identification data, data packets with measurements of inertial sensors, data packets with directions computed by the tracker, or combinations thereof. Each tracker may also receive data packets from the user device 108, for example, with tracking instructions. The trackers and/or the user device 108 may run sensor fusion algorithms, for example, to improve accuracy or correct errors in measurements.

The user device 108 may provide (or cause another device to provide) user-perceptible signals, such as exercise instructions or messages. For example, the display 1004 and one or more loudspeakers of the audio system 1006 may provide such user-perceptible signals. That is to say, the user device 108 may comprise one or more of visual output means, audio output means, vibrating means, or other means for providing user-perceptible signals in the form of sounds, vibration, animated graphics, etc.

For example, the display 1004 of the user device 108 may show instructions and/or information to the user 110 about the digital therapy program, such as predetermined movements that are to be performed by the user 110, a list or representation of the body members that should have a tracker arranged thereon for a given exercise or motion tracking procedure, or results of the exercises performed by the user 110. The user device 108 may thus provide a user interface to present instructions and/or information to the user and/or to receive inputs from the user. Any of these data can be transmitted to and/or received from another electronic device thanks to communicative couplings between the user device 118, the digital therapy platform 102, and the user device 108 (e.g., over the network 106 of FIG. 1). For example, the user 120 is able to receive the feedback at the user device 118 in a hospital (or other facility, such as an outpatient clinic, retirement home, or elderly care facility) so as to monitor the evolution or progress of the user 110.

In some examples, one or more of the trackers may include a vital sign sensor. Examples of vital sign sensors include a respiration rate sensor, a body temperature sensor, a pulse rate sensor, or a combination of two or more thereof. In some examples, one or more of the trackers, or the user device 108, also captures audio feedback via one or more audio sensors such that the audio feedback can be processed by the user device 108 or at the digital therapy platform 102 (e.g., to assist in determining the ease or difficulty experienced by the user 110 in performing the exercises).

The user 120 can manage, edit, or track the digital therapy programs of one or various patients on the user device 118. For example, based on sensor measurements and user-reported feedback received with respect to the user 110, the user 120 is able to monitor and adjust the digital therapy program by changing the difficulty of the movements or exercises, changing the number of repetitions thereof, prescribing new movements, and so forth. The user 110 may also be provided with educational content (e.g., tailored educational content) and/or CBT via the digital therapy application.

The digital therapy platform 102 provides for bidirectional communication with patients, for example, through a secure chat functionality or a text messaging facility available when the digital therapy application is installed on the user device 118 and the user device 108. This may enable, for example, virtual consultations or text message-based “chats” between patients and therapists. The user device 118 also includes, or is connected to, a camera 1012 and audio system 1016, for example, to facilitate such communications. As discussed with reference to the user device 108, the user device 118 also includes a display 1014, at least one processor, at least one memory, and a communication module (not shown) for communicating with the digital therapy platform 102 and one or more other devices.

A patient management user interface 1018 may be provided to the user 120 via a user interface presented on the display 1014 (e.g., a user interface of the digital therapy application). The patient management user interface 1018 allows the user 120 to track, manage, and/or interact with various patients assigned to them in the context of the digital therapy platform 102.

For example, after authenticating into the digital therapy platform 102 (e.g., logging into the digital therapy application), the user 120 can access the patient management user interface 1018 for their assigned patients (e.g., the user 110) or for each assigned patient. The patient management user interface 1018 may enable the user 120 to visualize baseline information, changes in patient data over time, including, for example, measured range of motion (e.g., using the trackers positioned on the patient's body, or computer vision techniques), self-reported pain ratings (e.g., a reported pain level after each session), utilization data, and/or fatigue levels. The patient management user interface 1018 can also provide predicted risk alerts, next steps, tasks, and/or timeline views of exercise activity to assist the user 120.

The patient management user interface 1018 may enable the user 120 to prescribe physical therapy interventions by selecting exercise regimens (these may be referred to as “prescriptions”) and scheduling follow-ups. In some examples, the patient management user interface 1018 is dynamically and automatically adjusted or updated to reflect the current state of the user 110 based on the latest measurements and predictions.

In some examples, the patient management user interface 1018 is provided by a patient management system of the digital therapy platform 102, examples of which are described below.

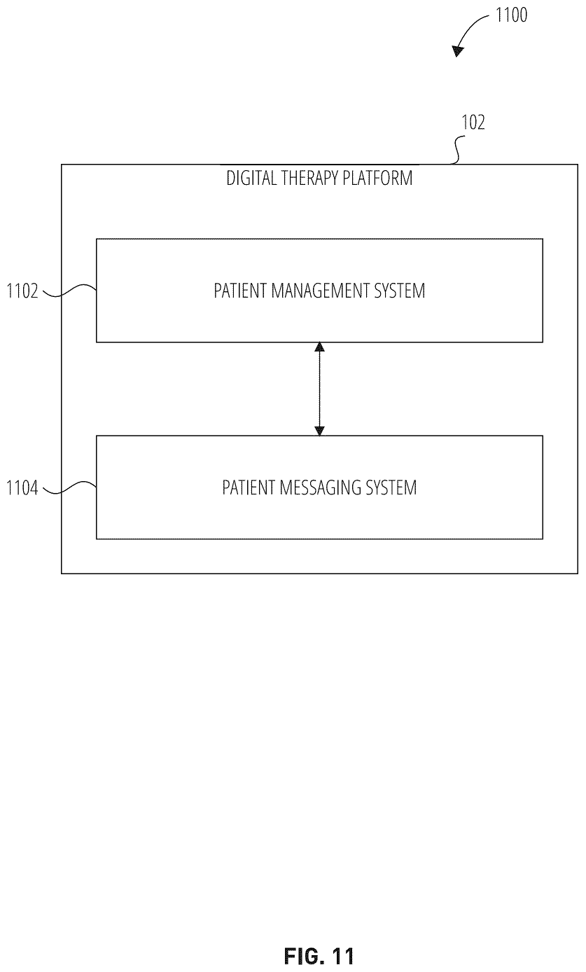

### Digital Therapy Platform 102 (FIG. 11)

FIG. 11 is an illustration 1100 of the digital therapy platform 102 of FIG. 1, according to some examples. In the case of FIG. 11, the digital therapy platform 102 includes a patient management system 1102 and a patient messaging system 1104. In some examples, through the combination of the patient management system 1102 and the patient messaging system 1104, the digital therapy platform 102 provides end-to-end, AI-powered digital therapy. As seen below, both the patient management system 1102 and the patient messaging system 1104 make use of automatically acquired patient data, such as motion tracking data that can be used to assess a patient's on-going performance of a prescribed exercise, and/or generate real-time cues or instructions as well as follow-up messages and/or physical exercises in an exercise regimen.

The patient management system 1102 is configured to process patient data and detect patient events. For example, when a patient event (e.g., completion of a therapy session, arrival of a new chat message, or a lack of patient engagement for a predetermined number of days) occurs, the patient management system 1102 automatically recommends an action through analysis of patient data (e.g., recent changes in patient data).

The patient management system 1102 may follow clinical guidelines to recommend an action to a (human) therapist (via the user device 118). For example, the patient management system 1102 may recommend to the therapist to adjust the digital therapy program to change the content of upcoming sessions, send a message to the patient, or intervene in some other way. The (human) therapist can then act efficiently, more quickly, and with greater context. For example, the patient management user interface 1018 may include a description of why an action is being recommended (e.g., one or more reasons). The therapist can then save significant time as less human review of patient data is needed prior to implementing a remedial action.

In some examples, the patient management system 1102 analyzes baseline patient data (e.g., individual characteristics, clinical conditions, patient needs, and/or goals) and sets an initial prescription (e.g., a starting protocol for the digital therapy program). The initial prescription can be assigned to the patient profile of the patient automatically or subject to therapist review/approval (e.g., within the patient management user interface 1018). The patient management system 1102 handles data from various data sources in order to generate the initial prescription.

The patient management system 1102 can automatically monitor patient progress over time (e.g., by checking motion tracking or activity assessment data, patient feedback from therapy sessions, therapist notes, and so forth) and introduce tailored prescription adjustments. In some examples, the patient management system 1102 generates recommended modifications for therapist review/approval (e.g., within the patient management user interface 1018). For example, the patient management system 1102 can automatically detect or predict that the patient is struggling with an exercise and recommend removal of that exercise from future sessions. As another example, the patient management system 1102 can automatically detect or predict that the patient is performing well and recommend increasing a difficulty level of future sessions. The patient management system 1102 can use a variety of data from multiple data sources for prescription adjustments, such as for example data from a real time data processing and environmental system (not shown) and/or data collection and management system (not shown). Such data can include acquired and processed motion tracking data as generated by a motion tracking component 214, which can be used to monitor and/or assess a patient's completion of one or more previous exercises.

The patient management system 1102 can also handle patient communications, or parts thereof. For example, the patient management system 1102 may analyze patient data and program context and generate recommended messages for transmission to the patient. The recommended messages may be subject to therapist review/approval. Messages may be delivered to the patient proactively (e.g., in response to detecting that the patient is struggling with an exercise) or in response to receiving a message from the patient. Again, the patient management system 1102 handles data from various data sources in order to generate messages.

In some examples, the patient management system 1102 leverages rules-based techniques and/or AI-driven techniques to perform its functions. The patient management system 1102 may utilize generative machine learning models, such as LLMs. In some examples, an LLM is fine-tuned on historic data of the digital therapy platform 102 (e.g., historic digital therapy programs, patient outcomes, and therapist-patient interactions) to improve the ability of the LLM to generate effective adjustments or recommendations.

The patient management system 1102 thus provides digital therapy program management as well as patient support to improve the efficiency of the digital therapy platform 102. The patient messaging system 1104 can supplement the patient management system 1102 by handling at least some patient communications, as described in greater detail below.

In some examples, the patient messaging system 1104 is responsible for in-session interactions with the patient. For example, the patient messaging system 1104 may generate personalized messages and/or real-time exercise instructions or cues that are delivered to the patient at certain points in time, and may also automatically respond to patient queries during a session.

The patient messaging system 1104 can also, in some cases, be responsible for delivering messages originating from the patient management system 1102. For example, where the patient management system 1102 recommends sending a motivational message to the patient between sessions (e.g., in response to detecting a patient event resulting from the patient not attending any sessions for a predetermined number of days) and the recommendation is approved by the therapist, the motivational message can be transferred to the patient messaging system 1104 for delivery or surfacing.

Where the patient messaging system 1104 interacts with the patient in real time during a therapy session, the patient messaging system 1104 may generate and transmit messages rapidly, without requiring user input, simulating the role of a human therapist who is working with and/or encouraging the patient in real time.

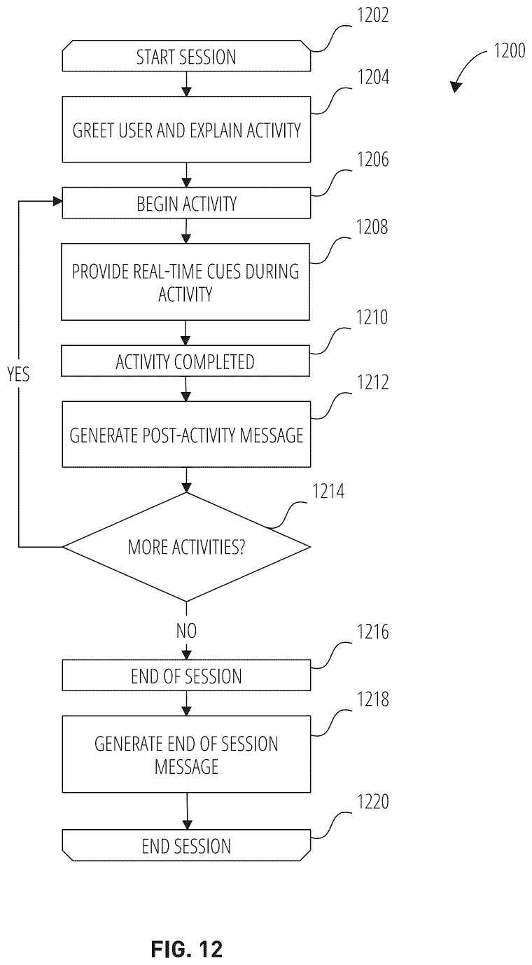

### Activity Session (FIG. 12)

FIG. 12 illustrates a method 1200 to conduct a session with a user, according to some examples. In some examples, the session is a digital therapy session performed by the digital therapy platform 102, or devices or systems coupled thereto (e.g., the user device 108). Accordingly, references below to operations performed by the digital therapy platform 102 may include operations performed at the server system 104 or another device or computing system, such as the user device 108. The digital therapy platform 102 is used below as an illustrative example only-in some examples, the session is performed by a computing system for an additional or alternative use case, such as motion capture technology for animation or film, a human-robot interaction platform, a VR/AR application, and so forth. Accordingly, the session structure, flow and/or operations can be used and/or adapted to any other use case requiring an interaction between a computing system and a user whose motion is being tracked and/or analyzed by the computing system. In some examples, the interaction takes place in the context of a session that includes one or more activities, such as for example physical activities (e.g., fitness-related or therapeutic exercises, and so forth).

The digital therapy platform 102 can provide timely, contextually relevant messages (e.g., AI-generated messages) that serve as touchpoints throughout a session, such a therapy session. These messages can be delivered at the beginning of the session, after the completion of each activity (e.g., therapeutic exercise) in the session, at the session's conclusion, or, alternatively, at different times and/or in different sequences.

The digital therapy platform 102 can generate a welcoming message personalized to the user's profile, taking into account factors such as their progress in the therapy program and the specific time of day. Following each physical activity in a therapy session, the digital therapy platform 102 analyzes the user's performance using algorithms that assess a variety of metrics, such as range of motion, pelvic area movements or forces, and/or the accuracy of movements. Based on this analysis, the digital therapy platform 102 crafts a post-activity message that provides personalized feedback that gives the user insight into their performance, by highlighting their achievements and areas of improvement. As the session draws to a close, the digital therapy platform 102 synthesizes data from the entire session to generate a concluding message. This message serves as a summary of the user's performance throughout the session, reinforcing positive behaviors and accomplishments while also setting goals and expectations for future sessions. In some examples, it is designed to leave the user with a sense of achievement and a clear understanding of their progress on their therapeutic journey.

Referring now specifically to the flowchart in FIG. 12, according to some examples, the digital therapy platform 102 starts a session (e.g., a therapy session) at opening loop element 1202. The digital therapy platform 102 initiates a new session when the user logs in, opts to start, or when a scheduled session time arrives. The digital therapy platform 102 loads the user's profile (e.g., as part of the digital therapy application described above), including scheduled physical activities (e.g., exercises) and historical data from previous sessions.

At operation 1204, the digital therapy platform 102 activates a personalized communication protocol, generating a welcoming message that is tailored to the user's identity (e.g., user's name) and current context. The digital therapy platform 102 intelligently considers contextual factors such as the time of day—for example offering a bright “Good morning” or a calming “Good evening”—and the user's journey within a program (e.g., a therapy program), recognizing milestones or encouraging continued progress.

The digital therapy platform 102 transitions to an educational mode, providing a succinct but detailed and understandable explanation of the activities that are slated for the session. The digital therapy platform 102 can accommodate a variety of instructional mediums. Visual learners can benefit from illustrative aids such as diagrams or animated sequences that demonstrate the exercises, while auditory learners may prefer spoken instructions. For users 110 who favor reading or require written instructions to supplement their understanding, the digital therapy platform 102 can generate descriptive text. The choice of instructional medium is determined by the user's pre-set preferences and the technological capabilities of the digital therapy platform 102.

The method 1200 initiates a physical activity regimen, such as an exercise regimen, at operation 1206. This stage can mark the transition from preparatory activities to the active engagement of the user in their prescribed activities (e.g., exercises). As the user embarks on the first physical activity (e.g., fitness or therapeutic exercise, etc.), the digital therapy platform 102 serves as an interactive guide, providing real-time instructions to ensure that the user performs each physical activity with precision and care.

The digital therapy platform 102, equipped with monitoring capabilities, digitally captures data regarding the user's movements (and, in some cases, other data, such as vital signs). The digital therapy platform captures a detailed account of the user's kinematics using computer vision technology (see, for example, FIG. 2) or an array of sensors. In this way, the digital therapy platform 102 can provide a comprehensive analysis of each motion, which can be used to generate real-time feedback ensuring the user's adherence to a correct form and/or technique. Specifically, as the user progresses through a physical activity, the digital therapy platform 102 analyzes each movement in real-time, using motion tracking technology (see, for example, the motion tracking component 214 in FIG. 2) or alternatively sensor technology, to capture detailed data on the user's movements. This data may include the speed, acceleration, and trajectory of limbs, as well as the overall posture and alignment of the body at various points during the movement. The digital therapy platform 102 can thus assess the accuracy and/or consistency of user movements in real-time. Should the user deviate from the prescribed form, the digital therapy platform 102 can offer real-time, personalized corrective cues designed to be intuitive and easily actionable, allowing the user to adjust their movements in real-time (see operation 1208). This immediate or real-time feedback can be helpful for preventing potential injuries and/or ensuring that the therapeutic benefits of an exercise are fully realized.

For example, the personalized cues can facilitate an interactive conversation between the “digital therapist” or coach provided by the digital therapy platform 102 and a user, enhancing the adaptability of the session to the user's capabilities and responses. The digital therapist might observe and comment, “You're struggling a bit with the upward part of the movement as you are losing your balance.” If the user acknowledges the difficulty, responding with “Indeed, but I don't seem to be able to do it!” the digital therapist can then offer actionable advice, such as, “Just focus on keeping your knees in place and rise slowly.” Additionally, the system is equipped to handle requests from the user, such as asking the digital therapist to skip a movement due to pain. In such cases, the digital therapist can respond with understanding and adapt the session accordingly, either by suggesting an alternative movement or physical activity or by providing reassurance and instructions for managing discomfort.

At operation 1210, the digital therapy platform 102 automatically determines that a movement or a physical activity is completed. Once the patient completes the physical activity, the digital therapy platform 102 processes the performance data to determine the quality of the movement execution, such as the range of motion achieved and the accuracy of movement(s). Upon the completion of a physical activity, the digital therapy platform 102 automatically detects this event using criteria such as the cessation of motion, the achievement of a target range of motion, or the completion of an expected number of repetitions.

According to some examples, the method 1200 includes generating a post-activity message at operation 1212. For example, the digital therapy platform 102 may use performance data to generate a post-activity message. This message includes personalized feedback on a user's performance, highlighting achievements like improved range of motion or a high percentage of correct movements. The message is crafted to be motivational and encouraging, using positive reinforcement techniques.

At decision operation 1214, the digital therapy platform 102 determines whether the session includes further scheduled physical activities. If more physical activities are planned, the digital therapy platform 102 proceeds to guide the patient to the next activity at operation 1206. If not, the digital therapy platform 102 transitions to the end-of-session phase.

Following a determination, at decision operation 1214, that no further physical activities are scheduled for the session, the digital therapy platform 102 ends the session at operation 1216. At the culmination of the session, the digital therapy platform 102 engages in a process of data compilation and synthesis. This process is not merely an aggregation of statistics but a strategic assembly of insights drawn from the user's exertions during the session.

The digital therapy platform 102 evaluates the user's performance, distilling the essence of their efforts into a coherent end-of-session message which is generated at operation 1218. This message serves as a comprehensive overview, providing the user with a clear picture of their performance (e.g., in the case of a patient, including progress made towards their therapy goals). It is a reflection of the user's journey through the session, capturing moments of strength, instances of improvement, and/or areas that may require further attention.

In some examples, the end-of-session message includes motivational elements, designed to motivate the patient to persist with their therapy regimen. It can be a blend of commendation and encouragement, acknowledging a user's hard work and dedication. The message may highlight specific accomplishments, such as achieving a new personal best in range of motion or maintaining a consistent pattern of correct movements (e.g., in the case of a patient, significant milestones in the patient's therapy journey). In some examples, the message also serves as a bridge to future sessions, providing the user with a sense of continuity and progression.

According to some examples, the method 1200 includes ending the session at closing loop element 1220. The digital therapy platform 102 officially ends the session, logs the session data for future reference, and/or may schedule the next session (e.g., based on a patient's therapy plan). The user may then log out or be logged out (e.g., of a digital therapy application as described above), or the system shuts down until the next scheduled session.

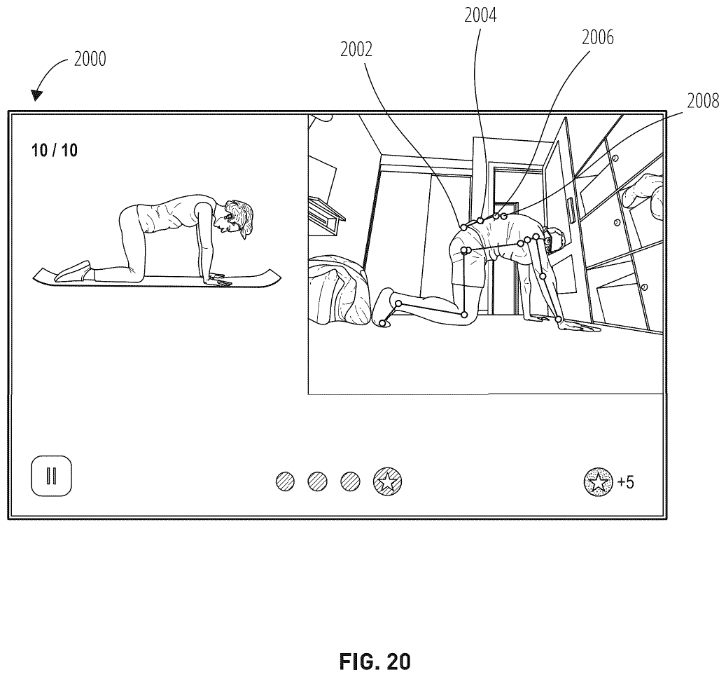

### Digital Therapy Platform Tracking and Assessment of Exercise Poses (FIG. 13 FIG. 20)

FIG. 13-FIG. 20 correspond to illustrations 1300, 1400, 1500, 1600, 1700, 1800, 1900 and 2000 of views of a user interface (UI) of digital therapy platform 102 at a computing device, according to some examples. The computing device can be a user device 108 of a patient, a device 118 of a therapist, and so on (see, for example, at least FIG. 1 or FIG. 10). FIG. 13-FIG. 20 showcase a digital therapy platform 102 or associated computing devices capturing images of a patient performing a physical activity, and the digital therapy platform 102 tracking and assessing the patient's movements as well as providing multiple types of feedback to help the patient effectively perform the prescribed physical activity, according to some examples.

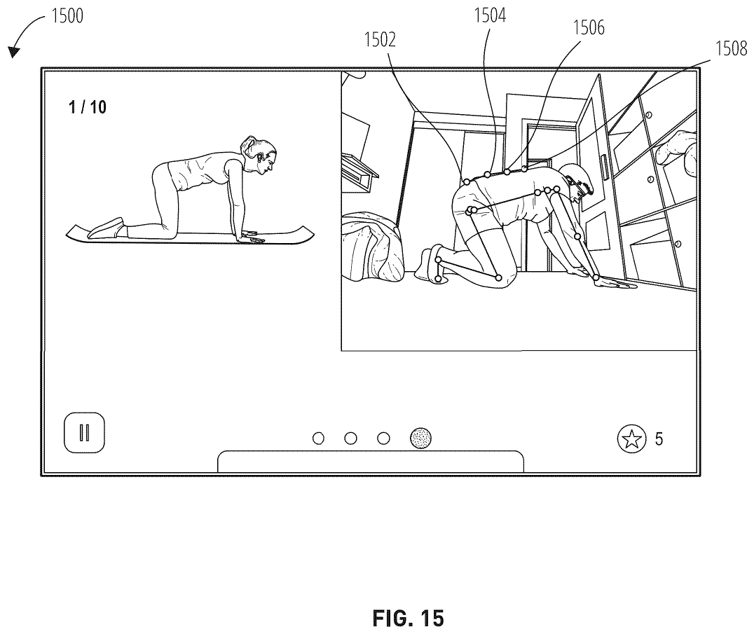

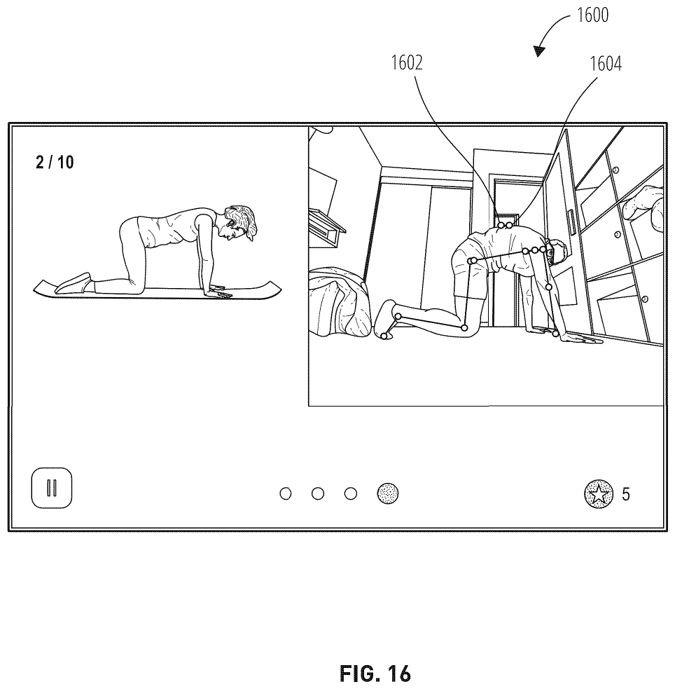

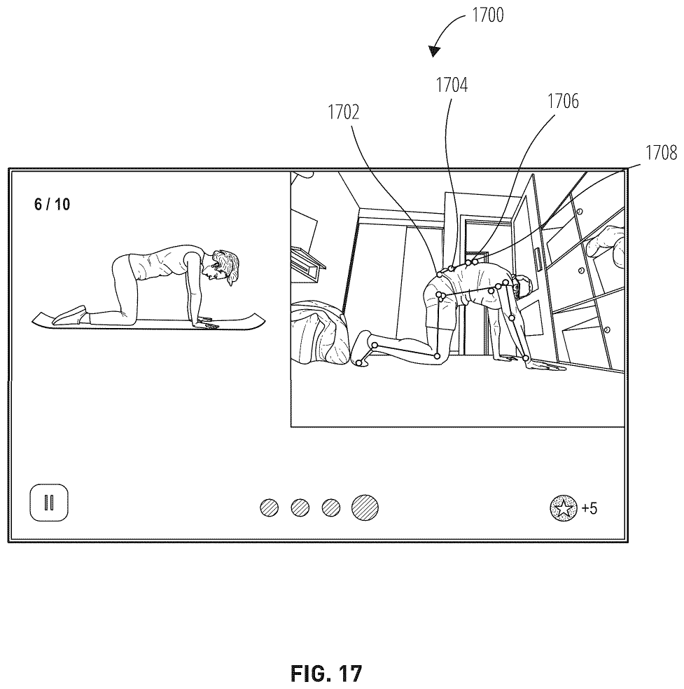

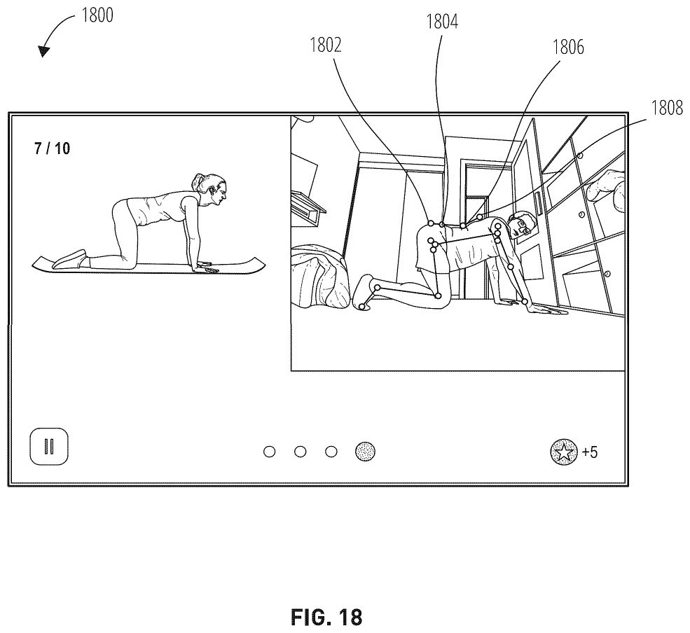

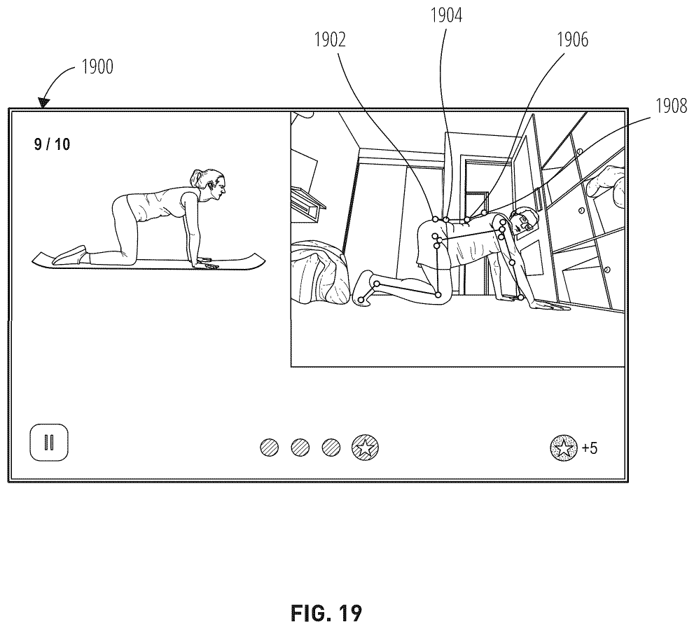

In the example of FIG. 13-FIG. 20, the physical activity is a prescribed movement of the back, such as a cat-cow movement, consisting of 10 steps of repetitions excerpted herein. The UI includes a visual representation of the patient's body, with highlighted keypoints and their associated locations in various frames. The keypoints include joint keypoints and newly generated body contour keypoints alongside the back of the patient, as shown in FIG. 15 through FIG. 20 (e.g., back keypoints 1502, 1504, 1506 and 1508 in FIGS. 15, 1602 and 1604 in FIGS. 16, 1702, 1704, 1706 and 1708 in FIGS. 17, 1802, 1804, 1806 and 1808 in FIGS. 18, 1902, 1904, 1906 and 1908 in FIGS. 19, 2002, 2004, 2006 and 2008 in FIG. 20). As seen in FIG. 17 through FIG. 20, the newly generated body contour keypoints on the back of the patient can be used to monitor the upwards and downwards back arching movements that are integral to the specific cat-cow physical activity. Should these keypoints be absent from the set of tracked keypoints, the digital therapy platform 102 would have a limited representation of the movements as performed by the patient, and would not be able to monitor the key parts of this exercise that is focused on back extension.

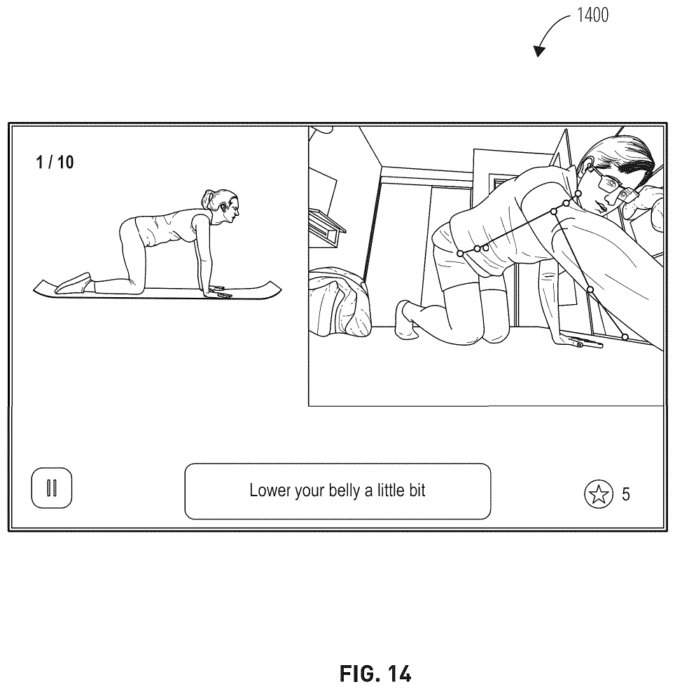

The digital therapy platform 102 provides feedback to the patient before, during, and/or after the completion of the physical activity repetitions or steps. Feedback can be provided in one or more of a variety of forms: written feedback, spoken or audio feedback (e.g., generated using speech synthesis by a text-to-speech conversion system, etc.), haptic feedback, feedback via one or more UI elements, and so forth. For example, FIG. 13 and FIG. 14 show explicit natural language instructions to the patient to modify his position in order to be sideways to the camera and/or correct the position of their stomach. As the physical activity progresses, the digital therapy platform 102 tracks and assesses the poses and/or movements of the patient based on the identified keypoints, determining whether the steps of the physical activity have been completed and further assessing the quality of the execution for each step. For example, as seen at least in FIG. 19 or FIG. 20, the digital therapy platform 102 informs the patient in near real-time, via UI elements such as color, completion indicators and/or rating-indicating or score-indicating visual elements (e.g., number of stars) that respective steps 9 and 10 have been completed with high accuracy. Alternatively, if the digital therapy platform 102 determines that the quality of execution is lacking, a real-time corrective instruction can be provided in a manner similar to the real-time instructions provided at the beginning of the physical activity.

The UI elements illustrated in FIG. 13 through FIG. 20 collectively demonstrate how the digital therapy platform 102 tracks, assesses, and provides feedback on a patient's movements during the back extension exercise, offering a comprehensive and interactive experience for the patient.

### Software Architecture 2102 (FIG. 21)

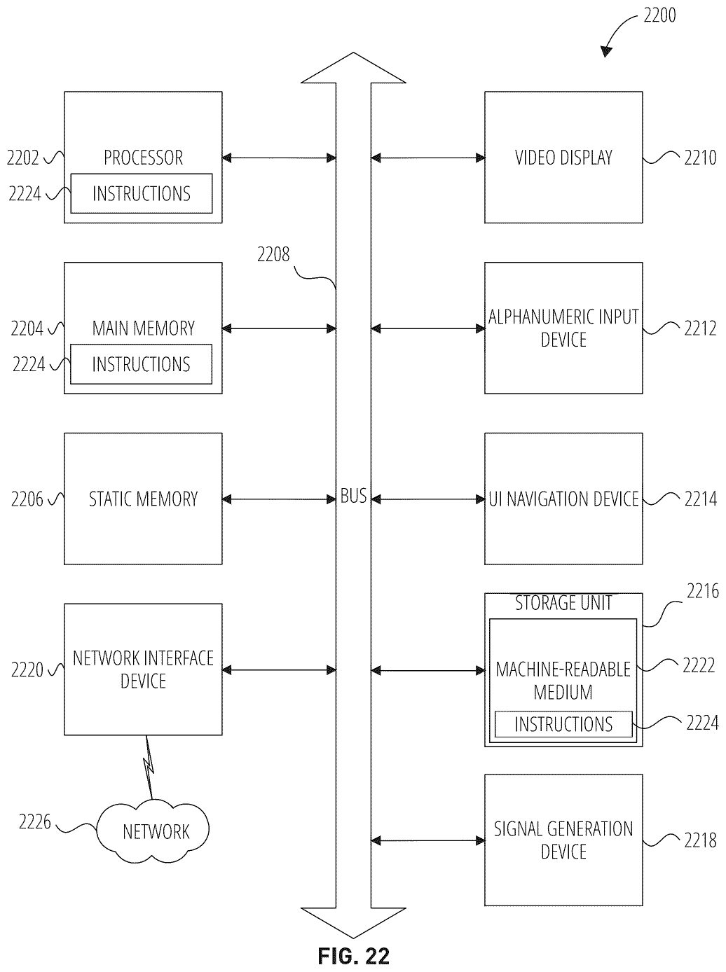

FIG. 21 is a block diagram 2100 showing a software architecture 2102 for a computing device, according to some examples. The software architecture 2102 may be used in conjunction with various hardware architectures, for example, as described herein. FIG. 21 is merely a non-limiting illustration of a software architecture, and many other architectures may be implemented to facilitate the functionality described herein. A representative hardware layer 2104 is illustrated and can represent, for example, any of the above referenced computing devices. In some examples, the hardware layer 2104 may be implemented according to the architecture of the computer system of FIG. 22.

The representative hardware layer 2104 comprises one or more processing units 2106 having associated executable instructions 2108. Executable instructions 2108 represent the executable instructions of the software architecture 2102, including implementation of the methods, modules, subsystems, and/or components, and so forth described herein and may also include memory and/or storage modules 2110, which also have executable instructions 2108. Hardware layer 2104 may also comprise other hardware as indicated by other hardware 2112 and other hardware 2122 which represent any other hardware of the hardware layer 2104, such as the other hardware illustrated or described as part of a computing device or computing system described herein.

In the architecture of FIG. 21, the software architecture 2102 may be conceptualized as a stack of layers where each layer provides particular functionality. For example, the software architecture 2102 may include layers such as an operating system 2114, libraries 2116, frameworks/middleware layer 2118, applications 2120, and presentation layer 2144. Operationally, the applications 2120 or other components within the layers may invoke calls, such as API calls 2124, through the software stack and access a response, returned values, and so forth illustrated as messages 2126 in response to the calls. The layers illustrated are representative in nature and not all software architectures have all layers. For example, some mobile or special purpose operating systems may not provide a frameworks/middleware layer 2118, while others may provide such a layer. Other software architectures may include additional or different layers.

The operating system 2114 may manage hardware resources and provide common services. The operating system 2114 may include, for example, a kernel 2128, services 2130, and drivers 2132. The kernel 2128 may act as an abstraction layer between the hardware and the other software layers. For example, the kernel 2128 may be responsible for memory management, processor management (e.g., scheduling), component management, networking, security settings, and so on. The services 2130 may provide other common services for the other software layers. In some examples, the services 2130 include an interrupt service. The interrupt service may detect the receipt of an interrupt and, in response, cause the software architecture 2102 to pause its current processing and execute an interrupt service routine (ISR) when an interrupt is accessed.

The drivers 2132 may be responsible for controlling or interfacing with the underlying hardware. For instance, the drivers 2132 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth, depending on the hardware configuration.

The libraries 2116 may provide a common infrastructure that may be utilized by the applications 2120 or other components or layers. The libraries 2116 typically provide functionality that allows other software modules to perform tasks in an easier fashion than to interface directly with the underlying operating system 2114 functionality (e.g., kernel 2128, services 2130, or drivers 2132). The libraries 2116 may include system libraries 2134 (e.g., C standard library) that may provide functions such as memory allocation functions, string manipulation functions, mathematical functions, and the like. In addition, the libraries 2116 may include Application Programming Interface (API) libraries 2136 such as media libraries (e.g., libraries to support presentation and manipulation of various media formats such as Moving Picture Experts Group Layer-4 (MPEG4), H.264, MP3, Advanced Audio Coding (AAC), Adaptive Multi-Rate (AMR), Joint Photographic Experts Group (JPG), Portable Network Graphics (PNG)), graphics libraries (e.g., an Open Graphics Library (OpenGL) framework that may be used to render two-dimensional and three-dimensional graphic content on a display), database libraries (e.g., SQLite that may provide various relational database functions), web libraries (e.g., WebKit that may provide web browsing functionality), and the like. The libraries 2116 may also include a wide variety of other libraries 2138 to provide many other APIs to the applications 2120 and other software components/modules.

The frameworks/middleware layer 2118 may provide a higher-level common infrastructure that may be utilized by the applications 2120 or other software components/modules. For example, the frameworks/middleware layer 2118 may provide various graphic user interface (GUI) functions, high-level resource management, high-level location services, and so forth. The frameworks/middleware layer 2118 may provide a broad spectrum of other interfaces, such as APIs, that may be utilized by the applications 2120 or other software components/modules, some of which may be specific to a particular operating system or platform.

The applications 2120 include built-in applications 2140 or third-party applications 2142. Examples of representative built-in applications 2140 may include, but are not limited to, a contacts application, a browser application, a book reader application, a location application, a media application, a messaging application, or a game application. Third-party applications 2142 may include any of the built-in applications as well as a broad assortment of other applications. In a specific example, the third-party application 2142 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 2142 may invoke the API calls 2124 provided by the mobile operating system such as operating system 2114 to facilitate functionality described herein.

The applications 2120 may utilize built in operating system functions (e.g., kernel 2128, services 2130, or drivers 2132), libraries (e.g., system libraries 2134, API libraries 2136, and other libraries 2138), and frameworks/middleware layer 2118 to create user interfaces to interact with users of the system. Alternatively, or additionally, in some systems, interactions with a user may occur through a presentation layer, such as presentation layer 2144. In these systems, the application/module “logic” can be separated from the aspects of the application/module that interact with a user.

Some software architectures utilize virtual machines. In the example of FIG. 21, this is illustrated by virtual machine 2148. A virtual machine creates a software environment where applications/modules can execute as if they were executing on a hardware computing device. A virtual machine is hosted by a host operating system (operating system 2114) and typically, although not always, has a virtual machine monitor 2146, which manages the operation of the virtual machine as well as the interface with the host operating system (e.g., operating system 2114). A software architecture executes within the virtual machine 2148 such as an operating system 2150, libraries 2152, frameworks/middleware 2154, applications 2156 or presentation layer 2158. These layers of software architecture executing within the virtual machine 2148 can be the same as corresponding layers previously described or may be different.

Certain examples are described herein as including logic or a number of components, modules, or mechanisms. Modules or components may constitute either software modules/components (e.g., code embodied (1) on a non-transitory machine-readable medium or (2) in a transmission signal) or hardware-implemented modules/components. A hardware-implemented module/component is a tangible unit capable of performing certain operations and may be configured or arranged in a certain manner. In examples, one or more computer systems (e.g., a standalone, client, or server computer system) or one or more hardware processors may be configured by software (e.g., an application or application portion) as a hardware-implemented module/component that operates to perform certain operations as described herein.

In various examples, a hardware-implemented module/component may be implemented mechanically or electronically. For example, a hardware-implemented module/component may comprise dedicated circuitry or logic that is permanently configured (e.g., as a special-purpose processor, such as a field programmable gate array (FPGA) or an application-specific integrated circuit (ASIC)) to perform certain operations. A hardware-implemented module/component may also comprise programmable logic or circuitry (e.g., as encompassed within a general-purpose processor or another programmable processor) that is temporarily configured by software to perform certain operations. It will be appreciated that the decision to implement a hardware-implemented module/component mechanically, in dedicated and permanently configured circuitry, or in temporarily configured circuitry (e.g., configured by software) may be driven by cost and time considerations.

Accordingly, the term “hardware-implemented module” or “hardware-implemented component” should be understood to encompass a tangible entity, be that an entity that is physically constructed, permanently configured (e.g., hardwired), or temporarily or transitorily configured (e.g., programmed) to operate in a certain manner or to perform certain operations described herein. Considering examples in which hardware-implemented modules/components are temporarily configured (e.g., programmed), each of the hardware-implemented modules/components need not be configured or instantiated at any one instance in time. For example, where the hardware-implemented modules/components comprise, a general-purpose processor configured using software, the general-purpose processor may be configured as respective different hardware-implemented modules/components at different times. Software may accordingly configure a processor, for example, to constitute a particular hardware-implemented module/component at one instance of time and to constitute a different hardware-implemented module/component at a different instance of time.

Hardware-implemented modules/components can provide information to, and receive information from, other hardware-implemented modules/components. Accordingly, the described hardware-implemented modules/components may be regarded as being communicatively coupled. Where multiple of such hardware-implemented modules/components exist contemporaneously, communications may be achieved through signal transmission (e.g., over appropriate circuits and buses that connect the hardware-implemented modules/components). In examples in which multiple hardware-implemented modules/components are configured or instantiated at different times, communications between such hardware-implemented modules/components may be achieved, for example, through the storage and retrieval of information in memory structures to which the multiple hardware-implemented modules/components have access. For example, one hardware-implemented module/component may perform an operation, and store the output of that operation in a memory device to which it is communicatively coupled. A further hardware-implemented module/component may then, at a later time, access the memory device to retrieve and process the stored output. Hardware-implemented modules/components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules/components that operate to perform one or more operations or functions. The modules/components referred to herein may, in some examples, comprise processor-implemented modules/components.

Similarly, the methods described herein may be at least partially processor-implemented. For example, at least some of the operations of a method may be performed by one or more processors or processor-implemented modules/components. The performance of certain of the operations may be distributed among the one or more processors, not only residing within a single machine, but deployed across a number of machines. In some examples, the processor or processors may be located in a single location (e.g., within a home environment, an office environment, or a server farm), while in other examples the processors may be distributed across a number of locations.

The one or more processors may also operate to support performance of the relevant operations in a “cloud computing” environment or as a “software as a service (SaaS).” For example, at least some of the operations may be performed by a group of computers (as examples of machines including processors), these operations being accessible via a network (e.g., the Internet) and via one or more appropriate interfaces (e.g., APIs).

Examples may be implemented in digital electronic circuitry, or in computer hardware, firmware, or software, or in combinations of them. Examples may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In examples, operations may be performed by one or more programmable processors executing a computer program to perform functions by operating on input data and generating output. Method operations can also be performed by, and apparatus of some examples may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various examples.

### Computer System 2200 (FIG. 22)

FIG. 22 is a block diagram of a machine in the example form of a computer system 2200 within which instructions 2224 may be executed for causing the machine to perform any one or more of the methodologies discussed herein. In alternative examples, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2200 includes a processor 2202, a primary or main memory 2204, and a static memory 2206, which communicate with each other via a bus 2208. The computer system 2200 may further include a video display unit 2210 (e.g., a liquid crystal display (LCD) or a cathode ray tube (CRT)). The computer system 2200 may also include an alphanumeric input device 2212 (e.g., a keyboard or a touch-sensitive display screen), a UI navigation (or cursor control) device 2214 (e.g., a mouse), a storage unit 2216, a signal generation device 2218 (e.g., a speaker), and a network interface device 2220.

As used herein, the term “processor” may include any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), an FPGA, a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, Very Long Instruction Word (VLIW), vector processing, or Single Instruction, Multiple Data (SIMD) that allow each core to run separate instruction streams concurrently. A processor may be emulated in software, running on a physical processor, as a virtual processor or virtual circuit. The virtual processor may behave like an independent processor but is implemented in software rather than hardware.

The storage unit 2216 includes a machine-readable medium 2222 on which is stored one or more sets of data structures and instructions 2224 (e.g., software) embodying or utilized by any one or more of the methodologies or functions described herein. The instructions 2224 may also reside, completely or at least partially, within the main memory 2204 or within the processor 2202 during execution thereof by the computer system 2200, with the main memory 2204 and the processor 2202 also each constituting a machine-readable medium 2222.

While the machine-readable medium 2222 is shown in accordance with some examples to be a single medium, the term “machine-readable medium” may include a single medium or multiple media (e.g., a centralized or distributed database, or associated caches and servers) that store the one or more instructions 2224 or data structures. The term “machine-readable medium” shall also be taken to include any tangible medium that is capable of storing, encoding, or carrying instructions 2224 for execution by the machine and that cause the machine to perform any one or more of the methodologies of the present disclosure, or that is capable of storing, encoding, or carrying data structures utilized by or associated with such instructions 2224. The term “machine-readable medium” shall accordingly be taken to include, but not be limited to, solid-state memories, and optical and magnetic media. Specific examples of a machine-readable medium 2222 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

The instructions 2224 may further be transmitted or received over a communications network 2226 using a transmission medium. The instructions 2224 may be transmitted using the network interface device 2220 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks. The term “transmission medium” shall be taken to include any intangible medium that is capable of storing, encoding, or carrying instructions 2224 for execution by the machine, and includes digital or analog communications signals or other intangible media to facilitate communication of such software.

### GLOSSARY

“DIGITAL THERAPY,” as used herein, may include a broad spectrum of health and wellness therapies, interventions, plans, programs, or activities delivered at least partially through digital means. Digital therapy can address or diagnose specific conditions and/or be aimed at promoting physical fitness or well-being and/or be aimed at preventative care. Digital therapy can include targeted therapeutic plans, such as those for MSK rehabilitation, pelvic-floor therapy, or behavioral therapy, or general activities that are not necessarily linked to a specific therapeutic condition, such as general fitness-related exercises, strength exercises, or injury prevention. Digital therapy programs can be personalized and interactive, where activities are tailored to an individual's health objectives, whether for specific therapeutic purposes or more general purposes (such as fitness enhancement).

“DIGITAL THERAPY PLATFORM,” as used herein, may include a technology-based or technology-driven platform designed to facilitate one or more health-related and/or wellness-related activities. Activities associated with a digital therapy platform can address or diagnose specific conditions, or promote physical fitness or well-being and/or aimed at preventative care, general or regular exercise, and so forth. A digital therapy platform may integrate or leverage various digital tools, such as mobile applications, web applications, wearable devices, computer vision-based or sensor-based motion trackers, other sensors, and/or interactive software to provide personalized solutions.

“PATIENT,” as used herein, may include a person making use of digital therapy or a digital therapy platform to facilitate health and/or wellness, whether generally or to address a specific condition or concern. A patient may be a person who engages with a digital therapy platform to seek guidance, support, or interventions. A patient may have a specific medical condition that needs to be addressed, or may utilize digital therapy for more general purposes or regular exercise. For example, a patient may be a person who utilizes the digital therapy platform for MSK rehabilitation through a targeted digital therapy program that includes exercises aimed at rehabilitating the person, or a person who utilizes the digital therapy platform to improve general fitness levels without having a targeted digital therapy program assigned to them.

“THERAPIST,” as used herein, may include a therapist (e.g., a physical therapist), clinician, physician, other healthcare professional, or worker (e.g., a coach, a personal trainer) that treats, manages, communicates with, or otherwise assists with advising, guiding, motivating, treating, or rehabilitating a patient in a digital therapy context or in a wellness-related or fitness-related context. A therapist can be a person assigned to work with one or more patients by offering advice, designing or adapting digital therapy programs, and/or providing motivation and support.

“THERAPY SESSION” (or simply “session”), as used herein, may include a patient/user engagement with the digital therapy platform. An engagement may involve the patient performing one or more exercises based on instructions or guidance provided by the digital therapy platform, in which case the session can be referred to as an exercise session. A session may be tailored to address a specific health condition (e.g., through targeted exercises). A session may be aimed at supporting general wellness, prevention, or fitness goals, without being targeted to a specific condition. Accordingly, a session may involve targeted or general exercises, depending on a patient's needs or requirements. For example, a therapy goal of a patient might be to address or alleviate a specific medical condition, or simply to improve overall health or well-being.

“POSE ESTIMATION,” as used herein, may include techniques for detecting and/or localizing key body parts or joints in images or video frames, typically represented as a set of keypoints. The keypoints can include anatomical landmarks or joint(s) keypoints that are located within the body structure. The keypoints can include, for example, facial features, anatomical parts such as chest bottom or back of neck, keypoints representative of shoulders, elbows, wrists, fingers, hips, knees, ankles, feet, and so forth. In some examples, such keypoint-based pose estimation techniques create a schematic (e.g., skeletal, etc.) representation of the human body. Localizing keypoints refers to identifying the positions of the respective keypoints for a particular image or video frame. For example, each keypoint can be associated with a set of coordinates, such as for example world coordinates (e.g., (X, Y, Z) coordinates) or other coordinate choices known in the art. In some examples, pose estimation approaches may include contour-based approaches that can be used to detect a body contour.

Furthermore, pose estimation approaches may include top-down methods that first detect people and then estimate poses, bottom-up methods that detect body parts and/or joints in an image and then group them and/or associate them with individuals, and so forth. In some cases, pose estimation techniques can be categorized into detection-based and regression-based approaches. Detection-based methods typically involve identifying and/or localizing specific body parts or joints in an image, such as by using heatmaps to represent the likelihood of a keypoint's presence at each pixel location. These methods can employ neural networks such as CNNs to generate heatmaps for each keypoint, followed by post-processing to extract the final keypoint coordinates. Regression-based approaches can directly predict the coordinates of keypoints based on an image. These methods may use ML models such as deep neural networks to learn a mapping from image features to keypoint coordinates, sometimes incorporating additional constraints or priors to improve accuracy.

“POSE TRACKING,” as used herein, may extend the concept of pose estimation by following a set of keypoints across multiple frames or video sequences and/or localizing them in the respective frames, thus allowing for the analysis of human motion over time. In some examples, pose tracking involves not only estimating poses in individual frames but also associating keypoints across frames to track the movement of body parts over time. Pose tracking approaches include frame-by-frame estimation, temporal model approaches, online tracking, and so forth. Frame-by-frame approaches may include applying pose estimation independently to each frame, and then linking the detected keypoints across frames using techniques like optical flow or temporal smoothing. Temporal model approaches may include incorporating temporal information directly into the pose estimation process, such as using RNNs or temporal convolutions to capture motion patterns. Online tracking may include using tracking algorithms (e.g., Kalman filters or particle filters) to predict and update keypoint locations based on previous frames and current observations. Additionally, instead of tracking only one person across frames, multi-person tracking may be performed, including tracking multiple individuals in a scene, often using data association techniques to maintain consistent identities across frames.

“MOTION TRACKING,” as used herein, may include a process or phase of following the movement of objects or people across multiple frames of video or a series of images.

Motion tracking may include capturing the overall trajectory and velocity of a subject, using techniques such as optical flow or feature matching to track specific points or regions of interest over time. Motion tracking may include, in some examples, the analysis of the pose of an object, person or group of people over a sequence of images/frames. Poses can be first detected and then evaluated individually and/or in the context of previous or subsequent poses in order to capture, analyze and/or output a more complex movement associated with the object, person or group of people. For example, an individual detection and/or evaluation procedure of a pose for a specific frame may result in a decision that the pose was detected and/or corresponds to a well-executed subset of a movement or activity (or not). Such a detection and/or evaluation operation can trigger positive, corrective, or other feedback (e.g., directed towards the person performing the movement). In some examples, a system checks whether a set or subset of expected poses in an expected partial or total order have been identified in a sequence of images or frames. The system can check that each of the detected poses, or each of a key subset of the detected poses, fulfill one or more correctness criteria. Based on one or more criteria associated with the number of detected poses, their detected order, and one or more measures of pose quality and/or accuracy, the system can generate and/or communicate an assessment of the performed movement or physical activity corresponding to the sequence of images or frames. As used herein, motion tracking may also be an umbrella term including pose estimation, pose tracking (e.g., as a specialized subset focused on estimating and tracking the positions of key body parts or joints over time and/or over a series of images or frames), as well as other subtasks or related tasks.

“MACHINE LEARNING PIPELINE,” as used herein, may refer to a pipeline including one or more of a data collection and/or preprocessing phase, a feature engineering phase, a model selection and/or training phase, a model evaluation phase, a prediction phase, a validation, refinement or retraining phase, a deployment phase, and more. A data collection and preprocessing phase may include acquiring, cleaning and/or performing initial processing of data to ensure that it is suitable for use in the machine learning model or for feature engineering purposes. This phase may also include removing duplicates, handling missing values, and/or converting data into a suitable format. Training data may be obtained or finalized at the end of data collection and preprocessing. A feature engineering phase may include selecting and transforming the training data set, or portions thereof, to create features that are useful for predicting a target variable. Feature engineering may include (1) receiving features (e.g., as structured or labeled data in supervised learning) and/or (2) identifying features (e.g., unstructured or unlabeled data for unsupervised learning) in the training data. Training data may be modified based on the outcomes of feature engineering. A model selection and training phase may include selecting an appropriate machine learning algorithm and training it on the preprocessed and/or feature-engineered data. This phase may further involve splitting the data into training and testing sets, using cross-validation to evaluate the model, and/or tuning hyperparameters to improve performance. A model evaluation phase may include evaluating the performance of a trained model on a separate testing data set. This phase can help determine if the model is overfitting or underfitting and determine whether the model is suitable for deployment. A prediction phase may involve using the trained model to generate predictions on new, unseen data. A validation, refinement or retraining phase may include updating a model based on feedback generated from the prediction phase, such as new data, new requirements, or user feedback. A deployment phase may include integrating the trained model into a more extensive system or application. This phase can involve setting up APIs, building a user interface, and ensuring that the model is scalable and can handle large or relatively large volumes of data. It will be appreciated that the trained model may be continuously or periodically updated, making the machine learning pipeline an iterative or partially iterative process. The performance of a machine learning model can be evaluated on a separate test set of data that was not used during training to ensure that the model can generalize to new, unseen data. A validation phase may be performed on a separate dataset known as the validation dataset. The validation dataset is used to tune the hyperparameters of a model, such as the learning rate and the regularization parameter. The hyperparameters are adjusted to improve the model's performance on the validation dataset. In a prediction or inference phase, the trained machine learning model uses the relevant features for analyzing query data to generate inferences, outcomes, or predictions. In some examples, a machine learning model may be fine-tuned, e.g., after initial deployment. The term “fine-tuning,” as used herein, generally refers to a process of adapting a pre-trained machine learning model. For example, a machine learning model may be adapted to improve its performance on a specific task or to make it more suitable for a specific operation. Fine-tuning techniques may include one or more of updating or changing a pre-trained model's internal parameters through additional training, injecting new trainable weights or layers into the model architecture and training on those weights or layers, modifying a model topology by altering layers or connections, changing aspects of the training process (such as loss functions or optimization methods), or any other adaptations that may, for example, result in better model performance on a particular task compared to the pre-trained model. Examples of specific machine learning algorithms and/or models are provided in examples herein.

### EXAMPLES

Example 1 is a computer-implemented method performed by a computer system comprising a memory and at least one hardware processor, the computer-implemented method comprising: accessing a first set of keypoints generated by processing at least one image of a body area of a person; generating a body mask by processing the at least one image of the body area of the person; processing the body mask to identify a second set of keypoints corresponding to a body contour of the body; in response to identifying the second set of keypoints, executing a predetermined function to identify a new keypoint based on the first set of keypoints and the second set of keypoints; generating a third set of keypoints based on the first set of keypoints and the new keypoint; tracking the third set of keypoints to generate motion tracking data; and generating feedback for the person based on the motion tracking data.

In Example 2, the subject matter of Example 1 includes, generating the first set of keypoints by processing the at least one image of the body area of the person via a pose estimation model.

In Example 3, the subject matter of Examples 1-2 includes, wherein the first set of keypoints comprises at least one of a joint landmark or a head region landmark.

In Example 4, the subject matter of Examples 1-3 includes, wherein the body mask corresponds to a segmentation mask generated by processing the at least one image of the body area of the person via a segmentation model.

In Example 5, the subject matter of Examples 1-4 includes, wherein: the body mask corresponds to a segmentation mask comprising pixels with corresponding numerical values associated with the body contour; and identifying the second set of keypoints corresponding to the body contour comprises determining a subset of the pixels whose corresponding numerical values are determined to fall within a predefined range.

In Example 6, the subject matter of Examples 1-5 includes, wherein the identifying of the new keypoint further comprises: determining an area based on the first set of keypoints; generating, using the first set of keypoints, a set of intermediate points in the area; computing for each keypoint of the second set of keypoints a value of a predetermined measure based on the respective keypoint and the set of intermediate points; and selecting the new keypoint to be a keypoint of the second set of keypoints whose associated value optimizes the predetermined measure with respect to a predetermined criterion.

In Example 7, the subject matter of Example 6 includes, wherein: generating the set of intermediate points further comprises generating a segment based on a plurality of landmarks retrieved from the first set of keypoints; and the predetermined measure is a distance measure based on each keypoint of the second set of keypoints and one or more points on the generated segment or an extension of the generated segment.

In Example 8, the subject matter of Example 7 includes, wherein computing, for each keypoint of the second set of keypoints, the value of the predetermined measure further comprises: generating a reference vector based on the segment; generating a candidate vector based on the keypoint and a keypoint of the segment; and computing an angle associated with the keypoint based on the candidate vector and the reference vector.

In Example 9, the subject matter of Example 8 includes, wherein selecting the new keypoint further comprises selecting a keypoint of the second set of keypoints associated with an angle of a set of computed angles associated with the second set of keypoints, wherein the angle satisfies a predefined selection criterion.

In Example 10, the subject matter of Examples 1-9 includes, wherein the identifying of the new keypoint further comprises: generating a first segment based on at least a first landmark of the first set of keypoints and one of at least a first contour point of the second set of keypoints or a first coordinate axis; generating a second segment based on at least a second landmark of the first set of keypoints and one of at least a second contour point of the second set of keypoints or a second coordinate axis; and selecting the new keypoint to correspond to a determined intersection of the first segment and the second segment.

In Example 11, the subject matter of Examples 1-10 includes, wherein the identifying of the new keypoint further comprises: computing for each keypoint of the second set of keypoints a value of a predetermined measure based on the respective keypoint and the first set of keypoints; and selecting the new keypoint to be a keypoint of the second set of keypoints whose associated value optimizes the predetermined measure with respect to a predetermined criterion.

In Example 12, the subject matter of Examples 1 -11 includes, wherein generating the third set of keypoints based on the first set of keypoints and the new keypoint comprises at least one of: augmenting the first set of keypoints using the new keypoint; or replacing one of the keypoints of the first set of keypoints with the new keypoint.

In Example 13, the subject matter of Examples 5-12 includes, wherein the numerical values associated with the body contour correspond to at least one of probabilities, grayscale range values, or RGB scale values.

In Example 14, the subject matter of Examples 1-13 includes, capturing the at least one image via a camera.

In Example 15, the subject matter of Examples 1-14 includes, wherein the new keypoint is automatically identified based on the first set of keypoints, the second set of keypoints, and a physical activity to be performed by the person, the method further comprising: capturing additional images of body areas of the person; and tracking the third set of keypoints across the additional images while the person performs the physical activity. The subject matter of Example 15 can further include presenting, at a user interface (UI), an instruction to the person for performing the physical activity.

In Example 16, the subject matter of Examples 1-15 includes, wherein: executing the predetermined function further comprises identifying a plurality of new keypoints, the new keypoints being selected to correspond to at least a majority of the second set of keypoints; and generating the third set of keypoints is further based on the plurality of new keypoints.

In Example 17, the subject matter of Examples 1-16 includes, generating feedback for the person based on the motion tracking data; and presenting, at a UI, the generated feedback in real-time to the person.

In Example 18, the subject matter of Examples 1-17 includes, wherein each keypoint in the first set of keypoints and the second set of keypoints is associated with X-axis, Y-axis and Z-axis coordinates.

Example 19 is a computer system comprising a memory and at least one hardware processor, the at least one hardware processor configured to perform operations comprising: accessing a first set of keypoints generated by processing at least one image of a body area of a person; generating a body mask by processing the at least one image of the body area; processing the body mask to identify a second set of keypoints corresponding to a body contour of the body; in response to identifying the second set of keypoints, executing a predetermined function to identify a new keypoint based on the first set of keypoints, and the second set of keypoints; generating a third set of keypoints based on the first set of keypoints and the new keypoint; and tracking the third set of keypoints to generate motion tracking data.

Example 20 is at least one non-transitory computer-readable storage medium, the at least one computer-readable storage medium including instructions that when executed by a computer, cause the computer to: access a first set of keypoints generated by processing at least one image of a body area of a person; generate a body mask by processing the at least one image of the body area; process the body mask to identify a second set of keypoints corresponding to a body contour of the body; in response to identifying the second set of keypoints, execute a predetermined function to identify a new keypoint based on the first set of keypoints, and the second set of keypoints; generate a third set of keypoints based on the first set of keypoints and the new keypoint; and track the third set of keypoints to generate motion tracking data.

Example 21 is a computer-implemented method performed by a computer system comprising a memory and at least one hardware processor, the computer-implemented method comprising: accessing a first set of keypoints generated by processing at least one image of a body area of a person; generating a body mask by processing the at least one image of the body area of the person; processing the body mask to identify a second set of keypoints corresponding to a body contour of the body area of the person; and executing a predetermined function to identify a new keypoint based on the first set of keypoints and the second set of keypoints.

In Example 22, the subject matter of Example 21 includes, tracking a movement of the person using the first set of keypoints, the new keypoint and at least one other image.

In Example 23, the subject matter of Example 22 includes, generating feedback for the person based on the movement that is tracked.

In Example 24, the subject matter of Examples 21-23 includes, generating the first set of keypoints by processing the at least one image of the body of the person via a pose estimation model.

In Example 25, the subject matter of Examples 21-24 includes, wherein the first set of keypoints comprises one of at least a joint landmark or a head region landmark.

In Example 26, the subject matter of Examples 21-25 includes, wherein the body mask corresponds to a segmentation mask generated by processing the at least one image of the body area of the person via a segmentation model.

In Example 27, the subject matter of Examples 21-26 includes, wherein: the body mask corresponds to a segmentation model comprising pixels with corresponding numerical values associated with the body contour; and identifying the second set of keypoints corresponding to the body contour comprises determining a subset of the pixels whose corresponding numerical values are determined to fall within a predefined range.

In Example 28, the subject matter of Examples 21-27 includes, wherein identifying the new keypoint further comprises: determining an area based on the first set of keypoints; generating, using the first set of keypoints, a set of intermediate points in the area; computing for each keypoint of the second set of keypoints a value of a predetermined measure based on the respective keypoint and the set of intermediate points; and selecting the new keypoint to be a keypoint of the second set of keypoints whose associated value optimizes the predetermined measure with respect to a predetermined criterion.

In Example 29, the subject matter of Example 28 includes, wherein generating the set of intermediate points further comprises: generating the set of intermediate points further comprises generating a segment based on a plurality of landmarks retrieved from the first set of keypoints; and the predetermined measure is a distance measure based on each keypoint of the second set of keypoints and one or more points on the generated segment or an extension of the generated segment.

In Example 30, the subject matter of Example 29 includes, wherein computing, for each keypoint of the second set of keypoints, the value of the predetermined measure further comprises: generating a reference vector based on the segment; generating a candidate vector based on the keypoint and a keypoint of the segment; and computing an angle associated with the keypoint based on the candidate vector and the reference vector.

In Example 31, the subject matter of Example 30 includes, wherein selecting the new keypoint further comprises selecting a keypoint of the second set of keypoints associated with an angle of a set of computed angles associated with the second set of keypoints, wherein the angle satisfies a predefined selection criterion.

In Example 32, the subject matter of Examples 21-31 includes, wherein the identifying of the new keypoint further comprises: generating a first segment based on at least a first landmark of the first set of keypoints and a first contour point of the second set of keypoints; generating a second segment based on at least a second landmark of the first set of keypoints and a second contour point of the second set of keypoints; and selecting the new keypoint to correspond to a determined intersection of the first segment and the second segment.

In Example 33, the subject matter of Examples 21-32 includes, wherein identifying the new keypoint further comprises: computing for each keypoint of the second set of keypoints a value of a predetermined measure based on the respective keypoint and the first set of keypoints; and selecting the new keypoint to be a keypoint of the second set of keypoints whose associated value optimizes the predetermined measure with respect to a predetermined criterion.

In Example 34, the subject matter of Examples 21-33 includes, augmenting the first set of keypoints using the new keypoint; or replacing one of the keypoints of the first set of keypoints with the new keypoint.

In Example 35, the subject matter of Examples 27-34 includes, wherein the numerical values associated with the body contour correspond to at least one of probabilities, grayscale range values, or RGB scale values.

In Example 36, the subject matter of Examples 21-35 includes, capturing the at least one image via a camera.

In Example 37, the subject matter of Examples 21-36 includes, wherein the new keypoint is automatically identified based on the first set of keypoints, the second set of keypoints, and a physical activity to be performed by the person, the method further comprising: capturing additional images of the body of the person; and tracking the new keypoint across the additional images while the person performs the physical activity.

In Example 38, the subject matter of Example 37 includes, presenting, at a user interface (UI), an instruction to the person for performing the physical activity.

In Example 39, the subject matter of Examples 23-38 includes, presenting, at a UI, the generated feedback in real-time to the person.

In Example 40, the subject matter of Examples 21-39 includes, wherein each keypoint in the first set of keypoints and the second set of keypoints is associated with X-axis, Y-axis and Z-axis coordinates.

Example 41 is a computer system comprising a memory and at least one hardware processor, the at least one hardware processor configured to perform operations comprising: accessing a first set of keypoints generated by processing at least one image of a body area of a person; generating a body mask by processing the at least one image of the body area of the person; processing the body mask to identify a second set of keypoints corresponding to a body contour of the body area of the person; executing a predetermined function to identify a new keypoint based on the first set of keypoints and the second set of keypoints.

Example 42 is at least one non-transitory computer-readable storage medium, the at least one non-transitory computer-readable storage medium including instructions that when executed by a computer, cause the computer, individually or in combination with another computer, to: access a first set of keypoints generated by processing at least one image of a body area of a person; generate a body mask by processing the at least one image of the body area of the person; process the body mask to identify a second set of keypoints corresponding to a body contour of the body area of the person; execute a predetermined function to identify at least one new keypoint based on the first set of keypoints and the second set of keypoints.

Example 43 is a computer-implemented method for tracking a movement of a body of a person using at least one image that captures the body of the person, the computer-implemented method comprising: identifying a first plurality of keypoints on the body of the person that is captured within the at least one image; generating a body mask with respect to the body of the person that is captured within the at least one image; identifying, using the body mask, a second plurality of keypoints along a contour of the body of the person that is captured within the at least one image; and tracking the movement of the body of the person using the first plurality of keypoints and the second plurality of keypoints.

In Example 44, the subject matter of Example 43 includes, wherein the first plurality of keypoints is generated using a pose estimation model.

In Example 45, the subject matter of Examples 43-44 includes, wherein the first plurality of keypoints comprises at least one of a joint landmark or a head region landmark.

In Example 46, the subject matter of Examples 43-45 includes, wherein the body mask corresponds to a segmentation mask generated using a segmentation model.

In Example 47, the subject matter of Example 46 includes, wherein the segmentation mask comprises pixels with corresponding numerical values associated with the body contour.

In Example 48, the subject matter of Example 47 includes, wherein the numerical values associated with the body contour correspond to at least one of probabilities, grayscale range values, or RGB scale values.

In Example 49, the subject matter of Examples 43-48 includes, capturing the at least one image via a camera on a mobile computing device.

In Example 50, the subject matter of Examples 43-49 includes, wherein the computer-implemented method is carried out on a mobile computing device.

In Example 51, the subject matter of Examples 43-50 includes, presenting, at a user interface (UI), an instruction to the person for performing a physical activity for which the movement of the body of the person is tracked.

In Example 52, the subject matter of Example 51 includes, simultaneously displaying on a display of a mobile computing device the first plurality of keypoints, the second plurality of keypoints, and the at least one image.

Example 53 is at least one non-transitory computer-readable storage medium including software configured to cause one or more processors, individually or in combination, to perform operations comprising: identifying a first plurality of keypoints on a body of a person that is captured within at least one image; generating a body mask with respect to the body of the person that is captured within the at least one image; identifying, using the body mask, a second plurality of keypoints along a contour of the body of the person that is captured within the at least one image; and tracking a movement of the body of the person using the first plurality of keypoints and the second plurality of keypoints.

In Example 54, the subject matter of Example 53 includes, wherein the first plurality of keypoints is generated using a pose estimation model.

In Example 55, the subject matter of Examples 53-54 includes, wherein the first plurality of keypoints comprises at least one of a joint landmark or a head region landmark.

In Example 56, the subject matter of Examples 53-55 includes, wherein the body mask is generated using a segmentation model.

In Example 57, the subject matter of Examples 53-56 includes, wherein the segmentation mask comprises pixels with corresponding numerical values associated with the body contour.

In Example 58, the subject matter of Example 57 includes, wherein the numerical values associated with the body contour correspond to at least one of probabilities, grayscale range values, or RGB scale values.

In Example 59, the subject matter of Examples 53-58 includes, the operations further comprising capturing the at least one image via a camera on a mobile computing device.

In Example 60, the subject matter of Examples 53-59 includes, wherein the at least one non-transitory medium is on a mobile computing device.

In Example 61, the subject matter of Examples 53-60 includes, the operations further comprising presenting, at a user interface (UI), an instruction to the person for performing a physical activity for which the movement of the body of the person is tracked.

In Example 62, the subject matter of Example 61 includes, the operations further comprising simultaneously displaying on a display of a mobile computing device, the first plurality of keypoints, the second plurality of keypoints, and the at least one image.

Example 63 is at least one machine-readable medium including instructions that, when executed by processing circuitry, cause the processing circuitry to perform operations to implement of any of Examples 1-62.

Example 64 is an apparatus comprising means to implement any of Examples 1-62.

Example 65 is a system to implement any of Examples 1-62.

Example 66 is a method to implement any of Examples 1-62.

Example 67 is a non-transitory computer-readable storage medium including instructions that when executed by a computer, cause the computer to implement any of Examples 1-62.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the inventive subject matter may be referred to herein, individually or collectively, by the term “example” merely for convenience and without intending to voluntarily limit the scope of this application to any single example or concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying”, “generating,” “selecting,” or the like may include actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to. ” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list.

Although some examples, such as those depicted in the drawings, may include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence. The term “operation” may be used to refer to elements in the drawings of this disclosure for ease of reference and it will be appreciated that each “operation” may identify one or more operations, processes, actions, or steps, and may be performed by one or multiple components.

Although each of the example methods depicts a particular sequence of operations, the sequence may be altered without departing from the scope of the present disclosure. For example, some of the operations depicted may be performed in parallel or in a different sequence that does not materially affect the function of the example method. In other examples, different components of an example device or system that implements the respective method. may perform functions at substantially the same time or in a specific sequence.

As used in this disclosure, the term “machine learning model” (or simply “model”) may include a single, standalone model, or a combination of models. The term may also refer to a system, component or module that includes a machine learning model together with one or more supporting or supplementary components that do not necessarily perform machine learning tasks.

What is claimed is:

1. A computer-implemented method performed by a computer system comprising a memory and at least one hardware processor, the computer-implemented method comprising:
accessing a first set of keypoints generated by processing at least one image of a body area of a person;
generating a body mask by processing the at least one image of the body area of the person;
processing the body mask to identify a second set of keypoints corresponding to a body contour of the body;
in response to identifying the second set of keypoints, executing a predetermined function to identify a new keypoint based on the first set of keypoints and the second set of keypoints;
generating a third set of keypoints based on the first set of keypoints and the new keypoint; and
tracking the third set of keypoints to generate motion tracking data.

2. The method of claim 1, further comprising generating the first set of keypoints by processing the at least one image of the body area of the person via a pose estimation model.

3. The method of claim 1, wherein the first set of keypoints comprises at least one of a joint landmark or a head region landmark.

4. The method of claim 1, wherein the body mask corresponds to a segmentation mask generated by processing the at least one image of the body area of the person via a segmentation model.

5. The method of claim 1, wherein:
the body mask corresponds to a segmentation mask comprising pixels with corresponding numerical values associated with the body contour; and
identifying the second set of keypoints corresponding to the body contour comprises determining a subset of the pixels whose corresponding numerical values are determined to fall within a predefined range.

6. The method of claim 1, wherein the identifying of the new keypoint further comprises:
determining an area based on the first set of keypoints;
generating, using the first set of keypoints, a set of intermediate points in the area;
computing for each keypoint of the second set of keypoints a value of a predetermined measure based on the respective keypoint and the set of intermediate points; and
selecting the new keypoint to be a keypoint of the second set of keypoints whose associated value optimizes the predetermined measure with respect to a predetermined criterion.

7. The method of claim 6, wherein:
generating the set of intermediate points further comprises generating a segment based on a plurality of landmarks retrieved from the first set of keypoints; and
the predetermined measure is a distance measure based on each keypoint of the second set of keypoints and one or more points on the generated segment or an extension of the generated segment.

8. The method of claim 7, wherein computing, for each keypoint of the second set of keypoints, the value of the predetermined measure further comprises:
generating a reference vector based on the segment;
generating a candidate vector based on the keypoint and a keypoint of the segment; and
computing an angle associated with the keypoint based on the candidate vector and the reference vector.

9. The method of claim 8, wherein selecting the new keypoint further comprises selecting a keypoint of the second set of keypoints associated with an angle of a set of computed angles associated with the second set of keypoints, wherein the angle satisfies a predefined selection criterion.

10. The method of claim 1, wherein the identifying of the new keypoint further comprises:
generating a first segment based on at least a first landmark of the first set of keypoints and one of at least a first contour point of the second set of keypoints or a first coordinate axis;
generating a second segment based on at least a second landmark of the first set of keypoints and one of at least a second contour point of the second set of keypoints or a second coordinate axis; and
selecting the new keypoint to correspond to a determined intersection of the first segment and the second segment.

11. The method of claim 1, wherein the identifying of the new keypoint further comprises:
computing for each keypoint of the second set of keypoints a value of a predetermined measure based on the respective keypoint and the first set of keypoints; and
selecting the new keypoint to be a keypoint of the second set of keypoints whose associated value optimizes the predetermined measure with respect to a predetermined criterion.

12. The method of claim 1, wherein generating the third set of keypoints based on the first set of keypoints and the new keypoint comprises at least one of:
augmenting the first set of keypoints using the new keypoint; or
replacing one of the keypoints of the first set of keypoints with the new keypoint.

13. The method of claim 5, wherein the numerical values associated with the body contour correspond to at least one of probabilities, grayscale range values, or RGB scale values.

14. The method of claim 1, further comprising capturing the at least one image via a camera.

15. The method of claim 1, wherein the new keypoint is automatically identified based on the first set of keypoints, the second set of keypoints, and a physical activity to be performed by the person, the method further comprising:
capturing additional images of body areas of the person; and
tracking the third set of keypoints across the additional images while the person performs the physical activity.

16. The method of claim 1, wherein:
executing the predetermined function further comprises identifying a plurality of new keypoints, the new keypoints being selected to correspond to at least a majority of the second set of keypoints; and
generating the third set of keypoints is further based on the plurality of new keypoints.

17. The method of claim 1, further comprising:
generating feedback for the person based on the motion tracking data; and
presenting, at a UI, the generated feedback in real-time to the person.

18. The method of claim 1, wherein each keypoint in the first set of keypoints and the second set of keypoints is associated with X-axis, Y-axis and Z-axis coordinates.

19. A computer system comprising a memory and at least one hardware processor, the at least one hardware processor configured to perform operations comprising:
accessing a first set of keypoints generated by processing at least one image of a body area of a person;
generating a body mask by processing the at least one image of the body area;
processing the body mask to identify a second set of keypoints corresponding to a body contour of the body;
in response to identifying the second set of keypoints, executing a predetermined function to identify a new keypoint based on the first set of keypoints, and the second set of keypoints;
generating a third set of keypoints based on the first set of keypoints and the new keypoint; and
tracking the third set of keypoints to generate motion tracking data.

20. At least one non-transitory computer-readable storage medium, the at least one computer-readable storage medium including instructions that when executed by a computer, cause the computer to:
access a first set of keypoints generated by processing at least one image of a body area of a person;
generate a body mask by processing the at least one image of the body area;
process the body mask to identify a second set of keypoints corresponding to a body contour of the body;
in response to identifying the second set of keypoints, execute a predetermined function to identify a new keypoint based on the first set of keypoints, and the second set of keypoints;
generate a third set of keypoints based on the first set of keypoints and the new keypoint; and
track the third set of keypoints to generate motion tracking data.
